(19) United States
(12) Patent Application Publication
(10) Pub. No.: US 2004/0164930 A1
(43) Pub. Date: Aug. 26, 2004

(54) Plasma display panel device and related drive method

(76) Inventors: Shinichiro Hashimoto, Toyonaka (JP); Masatoshi Kitagawa, Hirakata (JP); Yukihiro Morita, Hirakata (JP); Naoki Kosugi, Kyoto (JP)

Correspondence Address: Snell & Wilmer L.L.P., Suite 1200, 1920 Main Street, Irvine, CA, 92614-7230, US

(21) Appl. No.: 10/724,281

(22) Filed: Nov. 28, 2003

(30) Foreign Application Priority Data
Nov. 29, 2002 (JP) 2002-348540
May 12, 2003 (JP) 2003-133176
Jun. 4, 2003 (JP) 2003-159384
Aug. 5, 2003 (JP) 2003-286653

(51) Int. Cl. G09G 3/28

(52) U.S. Cl. 345/60

(57) ABSTRACT

A plasma display panel device having high luminance efficiency and a drive method for the PDP device, which includes a panel unit having a plurality of pairs of a first and a second electrode, and a plurality of third electrodes that intersect the electrode pairs to define a plurality of discharge cells, and a drive unit that drives the panel unit using a drive method having a write period and a sustain period, by applying, in the sustain period, a voltage to the third electrodes and a voltage to the electrode pairs, so as to generate a sustain discharge between the first and second electrodes in the sustain period, the drive unit applying the voltage to the third electrodes so as to change a potential of the third electrodes during the sustain discharge.

### BACKGROUND OF THE INVENTION

1. Field of the Invention

The present invention relates to plasma display panel devices and drive methods for the same, and in particular to improving the luminance efficiency of such devices.

2. Related Art

Much is expected of plasma display panel (PDP) devices due to their compatibility with high-vision broadcasting, and the relative ease with which screen size can be increased in comparison to the conventional cathode-ray tube (CRT) display devices which have dominated the image display device market to date. PDP devices can be broadly divided into alternating current (AC) and direct current (DC) types. Of these two types, AC-type PDP devices are currently favored for their reliability, image quality characteristics, and so forth.

AC PDP devices are driven using a field time-division grayscale display method in which each field is divided into a plurality of subfields and multiple grayscales are expressed by varying the combination of on/off subfields. The drive of a PDP device using the field time-division grayscale display method is described below using FIG. 32.

As shown in FIG. 32, each subfield is constituted from initialization, address and sustain periods. In the initialization period, a pulse is applied to sustain electrodes 53 and scan electrodes 54 so as to initialize all of the discharge cells. In the address period, a weak discharge is generated between scan electrodes 54 and data electrodes 62 in discharge cells to be turned on, in order to accumulate a required amount of wall charge in these cells. In the sustain period, an AC voltage is applied to sustain electrodes 53 and scan electrodes 54 so as to generate a sustain discharge in the cells that were written in the address period.

One problem area with PDP devices is the relatively low luminance efficiency in comparison with CRT display devices. Current attempts to ameliorate this deficiency focus on drive methods, drive circuits and the like. For example, one such technique developed to improve the drive method involves applying an extremely narrow pulse voltage of positive polarity to data electrodes 62 in the sustain period (hereinafter, pulse voltages applied to the data electrodes in the sustain period are called “sustain data pulses”). See, for instance, unexamined Japanese patent application publications no.11-143425, no.2001-5425, and no.2001-282182.

Applying the sustain data pulse in the sustain period generates a trigger discharge between data electrodes 62 and whichever of sustain electrodes 53 or scan electrodes 54 have negative wall charge formed thereover. The trigger discharge is not strong enough to eliminate all of the wall charge, and acts to trigger the sustain discharge between the sustain and scan electrodes. A sustain discharge originating from the trigger discharge is then generated between the sustain and scan electrodes. Use of a trigger discharge allows the discharge starting voltage to be set lower than when a trigger discharge is not used.

Consequently, with a drive method that applies this technique, a trigger discharge is generated by the application of a sustain data pulse to data electrodes 62 in the sustain period, making it possible to reduce the discharge starting voltage between the sustain and scan electrodes in the sustain period, and to improve the luminance efficiency of the PDP device in comparison to when a trigger discharge is not generated.

While the relative increase in luminance efficiency provided by the trigger discharge technique disclosed in the above prior art references is desirable, it is, however, clearly insufficient when considering the considerable improvements in luminance efficiency currently being sought in relation to PDP devices, as mentioned above.

### SUMMARY OF THE INVENTION

The present invention aims to resolve the above problem by providing both PDP devices exhibiting high luminance efficiency and related drive methods.

The inventors, in their research development into resolving the above problem, identified a close relationship between the luminance efficiency of the panel and the timing of the sustain data pulse applied in the sustain period.

As such, the present invention has the following features.

In a PDP device and a related drive method pertaining to the present invention, with respect to which the PDP device includes a panel unit having plural pairs of a first and a second electrode and a plurality of third electrodes that intersect the electrode pairs to define a plurality of discharge cells, and a drive unit that drives the panel unit using a drive method having a write period and a sustain period, by applying, in the sustain period, a voltage to the third electrodes and a voltage to the electrode pairs, so as to generate a sustain discharge between the first and second electrodes in the sustain period, the drive unit applies the voltage to the third electrodes in the sustain period so as to change the potential of the third electrodes during the sustain discharge.

With the above PDP device and drive method, it is possible to improve the luminance efficiency of the panel as a result of applying a voltage to the third electrodes in the sustain period, in addition to the voltage applied to the first and second electrodes.

With the above PDP device considerable improvements in luminance efficiency are made possible by controlling the voltage applied to the third electrodes during the sustain discharge so that the potential of the third electrodes changes during the sustain discharge. In other words, the formation of wall charge in discharge cells during the sustain period is affected by the potential of the electrodes at the end of the sustain discharge. Here, when the fall time of the voltage applied to the third electrodes is set to be after the sustain discharge, as in conventional PDP devices, it is not possible to modulate the sustain discharge, since even when the voltage is applied to the third electrodes in the lead up to the next sustain discharge, the electric field distribution simply reverts to a state when the wall change was formed. In short, continued modulation of the sustain discharge was considered impossible with conventional PDP devices.

In contrast, with the above PDP device and drive method, wall charge is formed in an electric field distribution state after the change in potential of the third electrodes, due to the potential of the third electrodes being changed prior to the end of the sustain discharge (i.e. during the sustain discharge). By changing the potential of the third electrodes again in the lead up to the next sustain discharge, it is possible to effect a change in the electric field distribution state, and thus modulate the sustain discharge.

Consequently, with the above PDP device and drive method, it is possible to realize sufficiently high luminance efficiency.

Also, with the above PDP device and drive method, a positive pulse voltage typically is applied to the third electrodes in the sustain period, and this voltage waveform typically is set to fall (from potential V1 to V2) during the sustain period. As a result, it is possible with the above PDP device and drive method to induce the sustain discharge path nearer the third electrodes than when a voltage is not applied to the third electrodes. By inducing the discharge path toward the third electrode, it is possible to lengthen the discharge path, which increases the positive column area, and to reduce any loss in ultraviolet light through self-absorption by having the discharge path approach the phosphor layers formed over the third electrodes.

Also, with the above PDP device and drive method, the voltage waveform applied to the third electrodes typically is set to rise (from potential V0 to V1) before the sustain discharge in the sustain period. Also, with the above PDP device and drive method, the voltage to the third electrodes typically is set, as described below, according to the voltage applied between the electrode pairs, in the case of the waveform of the sustain pulse applied between the electrode pairs in the sustain period having a slope requiring a duration T to least one of rise and fall.

(1) Examples are given below of when the voltage waveform applied to the electrode pairs in the sustain period (step) is a pulse waveform that alternates repeatedly between high and low potentials, the high periods being of equal duration to the low periods.

(1-1) In the case of duration T being 250 nsec±20%, the potential of the third electrodes is changed in a range of 0.1 μsec to 0.5 μsec after the voltage waveform applied to at least the first or second electrodes begins to change. This range typically is 0.2 μsec to 0.4 μsec.

(1-2) In the case of duration T being 500 nsec=20%, the potential of the third electrodes is changed in a range of 0.3 μsec to 0.7 μsec after the voltage waveform applied to at least the first or second electrodes begins to change. This range typically is 0.4 μsec to 0.6 μsec.

Considering (1-1) and (1-2) above, a time T typically is set so as to satisfy a relation in a range defined by points a1 (250, 0.1), b1 (250, 0.5), c1 (500, 0.3), and d1 (500, 0.7), when duration T is measured on the horizontal axis and time t is measured on the vertical axis. Time t more typically is set so as to satisfy a relation in a range defined by points a11 (250, 0.2), b11 (250, 0.4), c11 (500, 0.4), and d11 (500, 0.6). Also, the change in the potential of the third electrodes occurs in a range of T−0.15 μsec to T+0.25 μsec after the voltage waveform applied to at least the first or second electrodes begins to change. This range typically is T−0.05 μsec to T+0.15 μsec. Here, time t is the time at which the potential of the third electrodes changes when the waveform applied to at least one of the electrodes in the pairs begins to change.

(2) Examples are given below of when the voltage waveform applied to the electrode pairs in the sustain period (step) is a pulse waveform that alternates repeatedly between high and low potentials, the high periods being longer than the low periods.

(2-1) In the case of duration T being 250 nsec±20%, the potential of the third electrodes is changed in a range of 0.0 μsec to 0.5 μsec after the voltage waveform applied to at least the first or second electrodes begins to change. This range typically is 0.1 μsec to 0.3 μsec.

(2-2) In the case of duration T being 500 nsec±20%, the potential of the third electrodes is changed in a range of 0.2 μsec to 0.7 μsec after the voltage waveform applied to at least the first or second electrodes begins to change. This range typically is 0.3 μsec to 0.5 μsec.

Considering (2-1) and (2-2) above, a time t typically is set so as to satisfy a relation in a range defined by points a2 (250, 0.0), b2 (250, 0.5), c2 (500, 0.2), and d2 (500, 0.7), when duration T is measured on the horizontal axis and time t is measured on the vertical axis. Time t more typically is set so as to satisfy a relation in a range defined by points a21 (250, 0.1), b21 (250, 0.3), c21 (500, 0.3), and d21 (500, 0.5). Also, the change in the potential of the third electrodes occurs in a range of T−0.25 μsec to T+0.25 μsec after the voltage waveform applied to at least the first or second electrodes begin to change. This range typically is T−0.15 μsec to T+0.05 μsec. Here, time T is, the same as (1) above, the time at which the potential of the third electrodes changes when the waveform applied to at least one of the electrodes in the pairs begins to change.

(3) Examples are given below of when the voltage waveform applied to the electrode pairs in the sustain period (step) is a pulse waveform that alternates repeatedly between high and low potentials, the high periods being shorter than the low periods.

(3-1) In the case of duration T being 250 nsec±20%, for example, the potential of the third electrodes is changed in a range of 0.2 μsec to 0.6 μsec after the voltage waveform applied to at least the first or second electrodes begins to rise, or 0.2 μsec before to 0.2 μsec after the voltage waveform applied to at least the first or second electrode begins to fall. These ranges typically are 0.3 μsec to 0.5 μsec with respect to the rise in the voltage waveform to the electrode pairs, and 0.1 μsec to 0.1 μsec with respect to the fall in the voltage waveform to the electrode pairs.

(3-2) In the case of duration T being 500 nsec±20%, the potential of the third electrodes is changed in a range of 0.4 μsec to 0.8 μsec after the voltage waveform applied to at least the first or second electrodes begins to rise, or 0.0 μsec to 0.4 μsec after the voltage waveform applied to at least the first or second electrodes begins to fall. These ranges typically are 0.5 μsec to 0.7 μsec with respect to the rise in the voltage waveform to the electrode pairs, and 0.1 μsec to 0.3 μsec with respect to the fall in the voltage waveform to the electrode pairs.

Considering (3-1) and (3-2) above, a time t1 typically is set so as to satisfy a relation in a range defined by points a3 (250, 0.2), b3 (250, 0.6), c3 (500, 0.4), and d3 (500, 0.8), when duration T is measured on the horizontal axis and time t1 is measured on the vertical axis. Time t1 more typically is set so as to satisfy a relation in a range defined by points a31 (250, 0.3), b31 (250, 0.5), c31 (500, 0.5), and d31 (500, 0.7). Also, the change in the potential of the third electrodes occurs in a range of T−0.05 μsec to T+0.35 μsec after the voltage waveform applied to at least the first or second electrodes begins to rise. This range typically is T+0.05 μsec to T+0.25 μsec . Here, time t1 is the time at which the potential of the third electrodes changes when the waveform applied to at least one of the electrodes in the pairs begins to rise.

Also, a time t2 typically is set so as to satisfy a relation in a range defined by points a4 (250, −0.2), b4 (250, 0.2), c4 (500, 0.0), and d4 (500, 0.4), when duration T is measured on the horizontal axis and time t2 is measured on the vertical axis. Time t2 more typically is set so as to satisfy a relation in a range defined by points a41 (250, −0.1), b41 (250, 0.1), c41 (500, 0.1), and d41 (500, 0.3). Also, the change in the potential of the third electrodes occurs in a range of T−0.45 μsec to T−0.05 μsec after the voltage waveform applied to at least the first or second electrodes begins to fall. This range typically is 1-0.35 μsec to T−0.15 μsec. Here, time t2 is the time at which the potential of the third electrodes changes when the waveform applied to at least one of the electrodes in the pairs begins to fall.

In (1) to (3) above, duration T typically is set in a range having a width of ±20% with respect to a reference value typically in a range of 250 nsec to 800 nsec, and more typically in a range of 250 nsec to 500 nsec. Here, the +20% range width is to allow for fluctuations in duration T.

Also, with the above PDP device and drive method, the drive unit may include a detection subunit operable to detect characteristic of an image for display by the panel unit, and a control subunit operable to perform a control to change the potential of the third electrodes in the sustain period according to the detected characteristic.

As a result, with the above PDP device, it is possible to always secure a high luminance efficiency that is stable irrespective of the image for display. In other words, while it is possible with conventional PDP devices to improve luminance efficiency when displaying images having a certain brightness average by applying a voltage to the third electrodes, there is a limit to the improvements in luminance efficiency that can be achieved when displaying images having different brightness averages. In contrast, with the above PDP device and drive method pertaining to the present invention, it is possible to sustain a high luminance efficiency that is not affected by differences in the brightness averages of images for display, because of the potential of the third electrodes being changed according to the respective brightness averages of such images.

Specifically, it is possible to implement a structure in which the detection subunit is a brightness average detection unit operable to detect the brightness averages of images for display, and the control subunit performs controls to change the potential of the third electrodes based on detected brightness averages.

The inventors have also identified that the temperature of the panel unit affects luminance efficiency. This is thought to be due to changes in the constitution of members included in the panel unit, particularly the protective layer, due to changes in the panel temperature. For this reason, with the above PDP device and drive method, the detection subunit in the drive unit may be structured to also detect the panel temperature in addition to the brightness average, and the potential of the third electrodes or the timing of the voltage to the third electrodes in the sustain period changed, based on both detected brightness averages and panel temperatures. As a result, with the above PDP device, it is possible, in addition to the above effects, to always sustain high luminance efficiency, irrespective of changes in the usage environment (temperature) of the PDP device.

In a PDP device and a related drive method pertaining to the present invention, with respect to which the PDP device includes a panel unit having plural pairs of a first and a second electrode and a plurality of third electrodes that intersect the electrode pairs to define a plurality of discharge cells, and a drive unit that drives the panel unit using a drive method having a write period and a sustain period, by applying, in the sustain period, a voltage to the third electrodes and a voltage to the electrode pairs, so as to generate a sustain discharge between the first and second electrodes in the sustain period, the drive unit applies the voltage to the third electrodes in the sustain period so as to change the potential of the third electrodes during the sustain discharge.

When the potential of the third electrodes is changed during the sustain discharge, it is possible to improve the luminance efficiency of the panel by lengthening the positive column region and improving ultraviolet production efficiency, as a result of hastening (i.e. bringing forward) the timing of the sustain discharge, making the area of the sustain discharge (discharge path) approach nearer the phosphor layers and the third electrodes, and lengthening the discharge path, in comparison to when the potential of the third electrodes is not changed.

In the above PDP device and drive method, the voltage waveform of the third electrodes typically is controlled to fall according to the above timing, so as to achieve improvements in luminance efficiency.

### BRIEF DESCRIPTION OF THE DRAWINGS

These and other objects, advantages, and features of the invention will become apparent from the following description thereof taken in conjunction with the accompanying drawings, which illustrate specific embodiments of the present invention.

In the drawings:

FIG. 1 is a block diagram showing the structure of a PDP device 1000 pertaining to an embodiment 1;

FIG. 2 is a plan diagram showing a panel unit 100 in PDP device 1000;

FIG. 3 is a perspective diagram (partial cross-section) showing a main section of panel unit 100;

FIG. 4 is a chart showing pulse waveforms applied to the electrodes during the drive of PDP device 1000;

FIG. 5 is a chart showing pulse waveforms applied to the electrodes in a sustain period;

FIG. 6 is a characteristic diagram showing the relationship between luminance efficiency and the fall time of a sustain data pulse;

FIG. 7 is a characteristic diagram showing the relationship between the half-width of a luminance waveform and the fall time of the sustain data pulse;

FIG. 8 is a chart showing pulse waveforms applied to the electrodes in the sustain period, during the drive of a PDP device 1100 pertaining to an embodiment 2;

FIG. 9 is a characteristic diagram showing the relationship between luminance efficiency and the fall time of the sustain data pulse;

FIG. 10 is a characteristic diagram showing the relationship between the half-width of a luminance waveform and the full time of the sustain data pulse;

FIG. 11 is a chart showing pulse waveforms applied to the electrodes in the sustain period, during the drive of a PDP device 1200 pertaining to an embodiment 3;

FIG. 12 is a characteristic diagram showing the relationship between luminance efficiency and the fall time of the sustain data pulse;

FIG. 13 is a characteristic diagram showing the relationship between luminance efficiency and the fall time of the sustain data pulse;

FIG. 14 is a characteristic diagram showing the relationship between the half-width of a luminance waveform and the fall time of the sustain data pulse;

FIG. 15 is a schematic diagram showing the change in the sustain discharge path in the PDP devices pertaining to embodiments 1 to 3;

FIG. 16 is a chart showing pulse waveforms applied to the electrodes in the sustain period, during the drive of a PDP device 1300 pertaining to an embodiment 4;

FIG. 17 is a chart showing pulse waveforms applied to the electrodes in the sustain period, during the drive of a PDP device 1400 pertaining to an embodiment 5;

FIGS. 18A & 18B are plan diagrams showing electrode configurations in a PDP device 1500 pertaining to an embodiment 6;

FIG. 19 is a chart showing pulse waveforms applied to the PDP device 1500;

FIG. 20 is a schematic diagram showing the change in the sustain discharge path in PDP device 1500;

FIG. 21 is a block diagram showing the structure of a PDP device 2000 pertaining to an embodiment 7;

FIG. 22 is a chart showing pulse waveforms applied to the electrodes in the sustain period, during the drive of PDP device 2000;

FIG. 23 is a characteristic diagram showing the relationship between luminance efficiency and the fall time of the sustain data pulse at a brightness average of 10%;

FIG. 24 is a characteristic diagram showing the relationship between luminance efficiency and the fall time of the sustain data pulse at a brightness average of 100%;

FIG. 25 is a characteristic diagram showing optimal fall times of the sustain data pulse for different brightness averages;

FIG. 26 is a flow diagram of processing conducted by a pulse-processing unit 241 in PDP device 2000;

FIG. 27 is a characteristic diagram showing the timing of pulses applied to the electrodes in the sustain period, during the drive of PDP device 2000;

FIG. 28 is a block diagram showing the structure of a PDP device 3000 pertaining to an embodiment 8;

FIG. 29 is a characteristic diagram showing the relationship between luminance efficiency and the fall time of the sustain data pulse at a panel temperature of 27° C.;

FIG. 30 is a characteristic diagram showing the relationship between luminance efficiency and the fall time of the sustain data pulse at a panel temperature of 65° C.;

FIG. 31 is a characteristic diagram showing optimal fall times of the sustain data pulse for different panel temperatures; and

FIG. 32 is a chart showing pulse waveforms applied to the electrodes during the drive of a conventional PDP device.

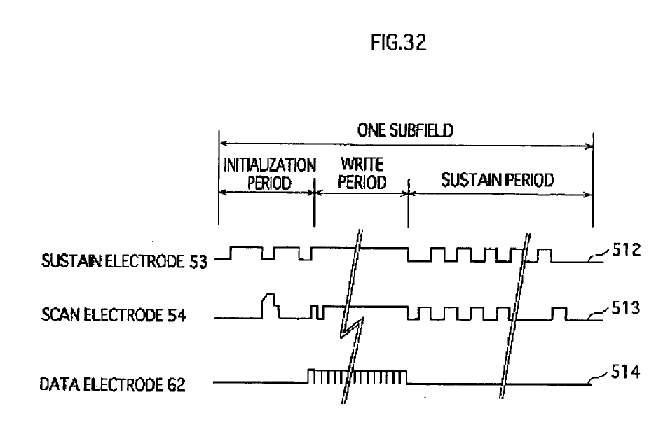

### DETAILED DESCRIPTION OF THE PREFERRED EMBODIMENTS

PDP devices and related drive methods pertaining to the present invention are described below with reference to the drawings.

### Embodiment 1

### 1. Overall Structure of PDP Device 1000

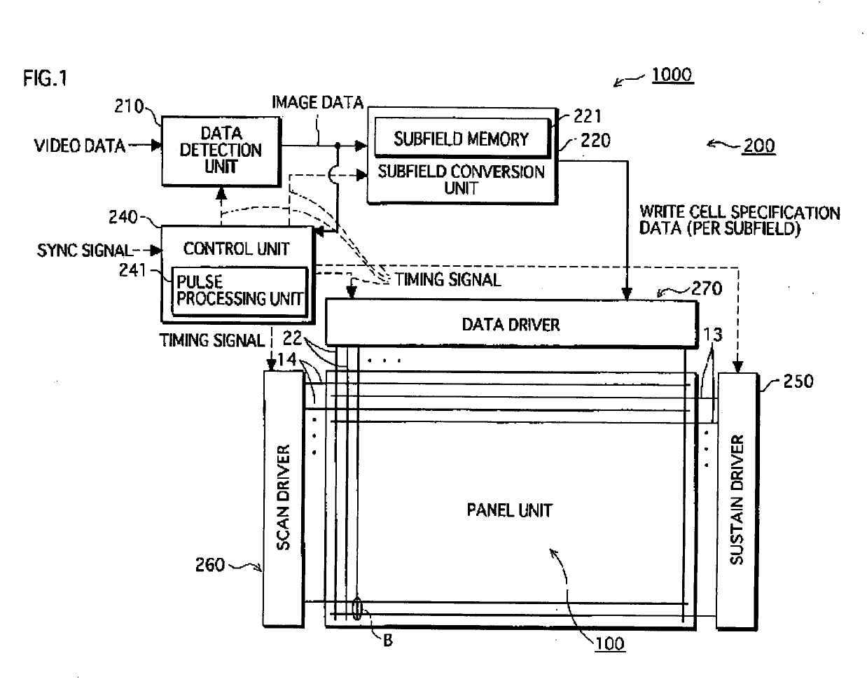

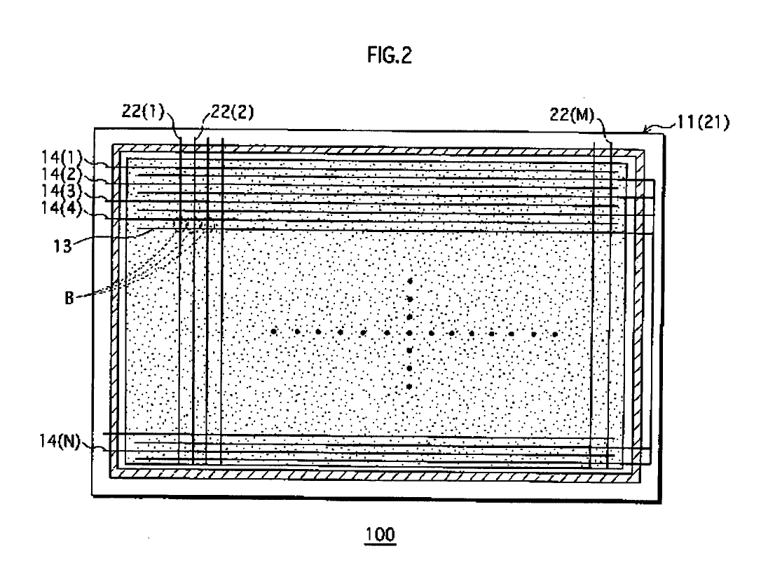

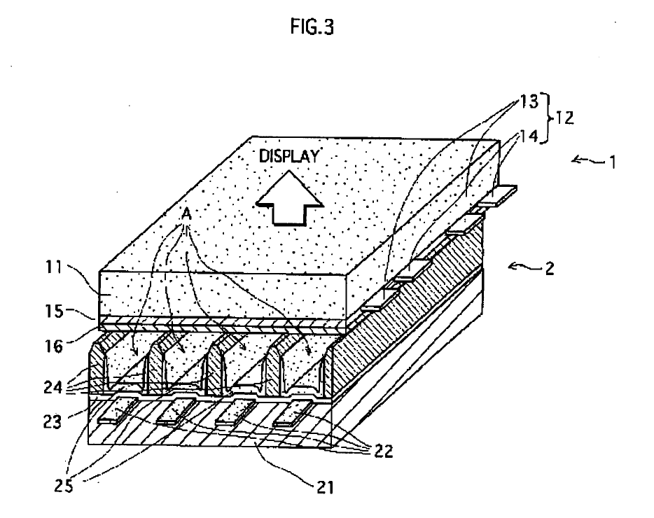

Firstly, the overall structure of a plasma display panel (PDP) device 1000 pertaining to an embodiment 1 will be described using FIGS. 1 to 3. FIG. 1 is a block diagram showing the overall structure of PDP device 1000. FIG. 2 is a plan diagram schematically showing an electrode configuration of a panel unit 100. FIG. 3 is a perspective diagram (partial cross-section) showing part of panel unit 100.

As shown in FIG. 1, PDP device 1000 is constituted from panel unit 100, which displays images, and a drive unit 200 for driving panel unit 100 using a field time-division grayscale method.

### 1-1. Structure of Panel Unit 100

As shown in FIG. 2, in panel unit 100, a plurality of display electrode pairs 12 (see FIG. 3) of a sustain electrode 13 and a scan electrode 14 are formed in a stripe pattern, and a plurality of data electrodes 22(1), to 22(M) that intersect display electrode pairs 12 are also formed in a stripe pattern. Display electrode pairs 12 are provided on a front glass substrate 11, and data electrodes 22 are provided an a back glass substrate 21. The front and back glass substrates are disposed so that display electrode pairs 12 and data electrodes 22 intersect. Each point of intersection between a display electrode pair 12 and a data electrode 27 defines a discharge cell.

As shown in FIG. 3, panel unit 100 is structured from a front panel 1 and a back panel 2. The space between the panels 1 and 2 is a discharge space A. Front panel 1 includes sustain electrodes 13 and scan electrodes 14 provided alternately on front glass substrate 11, a dielectric layer 15 formed over the surface of front glass substrate 11 on which the sustain and scan electrodes (display electrode pairs 12) have been provided, and a protective layer 16 formed over dielectric layer 15. Here, display electrode pairs 12 are formed according to the number of pixels in the column direction of panel unit 100.

Back panel 2 includes data electrodes 22 provided on back glass substrate 21, a dielectric layer 23 formed over the surface of back glass substrate 21 on which data electrodes 22 have been provided, and barrier ribs 24 disposed in a stripe pattern on dielectric layer 23. Back panel 2 also includes red (R), green (G) and blue (B) phosphor layers 25 formed on the bottom and walls of grooves defined by dielectric layer 23 and adjacent barrier ribs 24. Here, three data electrodes 22 are provided for every pixel in the row direction of panel unit 100.

The front and back panels are affixed together around a perimeter area using frit glass or the like, so as to face each other with display electrode pairs 12 intersecting data electrodes 22. Discharge space A, which exists between the two panels, is filled with a discharge gas (e.g. Ne-Xe gas, He-Xe gas, etc.).

Electrodes 13, 14 and 22 are formed using metals such as gold (Au), silver (Ag), copper (Cu), chrome (Cr), nickel (Ni), and platinum (Pt). Sustain electrodes 13 and scan electrodes 14 may also be formed by laminating Ag on a wide transparent electrode made from a conductive metal oxide such as indium tin oxide (ITO), tin oxide (SnO₂), and zinc oxide (ZnO).

Dielectric layers 15 and 23 can be formed using low-melting load glass, low-melting bismuth glass, a laminate of low-melting lead glass and low-melting bismuth glass, or the like. Protective layer 16 is a thin film made from magnesium oxide (MgO).

### 1-2. Structure of Drive Unit 200

The structure of drive unit 200 in PDP device 1000 is described below, referring again to FIG. 1.

As shown in FIG. 1, drive unit 200 is constituted from a data detection unit 210, a subfield conversion unit 220, a control unit 240, a sustain driver 250, a scan driver 260, and a data driver 270. Of these, data detection unit 210 detects image data (i.e. grayscale values of individual discharge cells) for each screen from video data inputted from an external source, and transfers the detected data sequentially to subfield conversion unit 220. Here, detection of the image data can be implemented using a vertical synchronization signal included in the video data as a reference. Also, in the case of individual discharge cells being displayed using 256 grayscales, the grayscale value of each cell is expressed by 8-bit image data.

Subfield conversion unit 220 includes a subfield memory 221. Unit 220 converts the image data transferred from data detection unit 210 into subfield data, which are groupings of binary data for grayscale display by panel unit 100 that show the on/off state of cells in each subfield. Unit 220 stores the subfield data in subfield memory 221. Unit 220 outputs stored subfield data to data driver 270 under the control of control unit 240.

Synchronization signals (horizontal synchronization signals or “Hsync”, vertical synchronization signals or “Vsync”) are inputted to control unit 240 in sync with the video data. Unit 240 outputs timing signals to (i) data detection unit 210 indicating the transfer timing of image data, (ii) subfield conversion unit 220 indicating the write/read timing to and from subfield memory 221, (iii) sustain driver 250, scan driver 260 and data driver 270 indicating the application timing of pulse voltages.

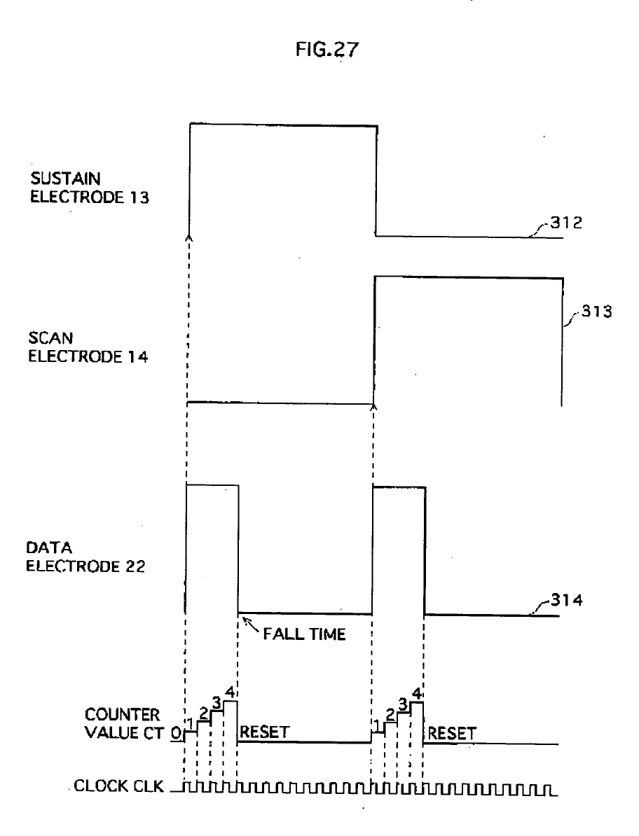

Control unit 240 includes a pulse-processing unit 241. Unit 240 uses unit 241 to set the rise/fall timing of the sustain data pulse applied in the sustain period. Unit 241 sets the rise/fall timing of the sustain data pulse with respect to a preset sustain pulse, using the same method as that described below in embodiment 7 (FIG. 27). A detailed description of the rise/fall timing of the sustain data pulse is given in a later section.

Sustain driver 250, which employs a known driver IC circuit, is connected to sustain electrodes 13 provided on front panel 1 of panel unit 100. Driver 250 applies initialization and sustain pulses to sustain electrodes 13 in the initialization and sustain periods, respectively, of each subfield, so as to allow stable initialization, sustain and erase discharges to be generated in all of the discharge cells.

Scan driver 260, which employs a known driver IC circuit, is connected to scan electrodes 14 provided on front panel 1 of panel unit 100. Driver 260 applies initialization, write and sustain pulses to scan electrodes 14 in the initialization, write and sustain periods, respectively, of each subfield, so as to allow stable initialization, write and sustain discharges to be generated in all of the discharge cells.

Data driver 270, which employs a known driver IC circuit (e.g. driver IC circuit disclosed in FIG. 1 of unexamined Japanese patent application publication 2002-287691), is connected to data electrodes 22 provided on back panel 2 of panel unit 100. Driver 270 selectively applies a write pulse to data electrodes 22 in the write period of each subfield and a sustain data pulse to all of the data electrodes 22 in the sustain period, so as to allow stable write and sustain discharges to be generated in all of the discharge cells.

### 1-3. Drive Method for PDP Device 1000

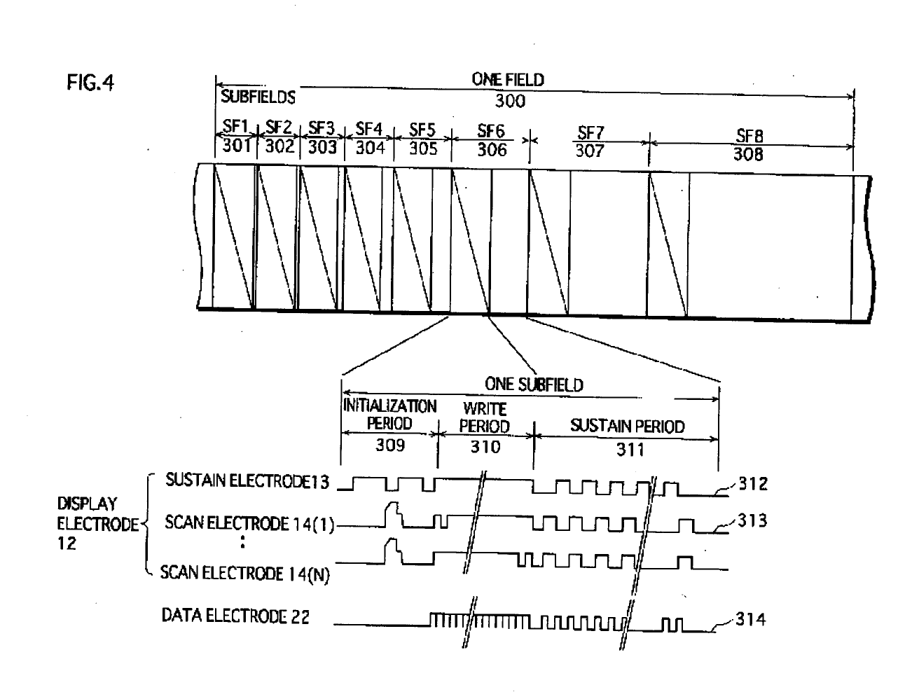

PDP device 1000 pertaining to embodiment 1 uses a field time-division grayscale display method as the drive method for displaying multiple grayscales. According to this method, one field is divided into a plurality of subfields and intermediate grayscales are expressed by varying the combination of on/off subfields. This drive method is described below using FIG. 4.

FIG. 4 shows the exemplary division of a single field 300 when expressing 256 grayscales. Time is shown from left to right across the page, and the periods marked by the vertical slanting lines indicate an initialization period 309 and a write period 310 in each subfield. Field 300 is divided into eight subfields 301 to 308 according to the division method shown in FIG. 4. The number of sustain pulses in each of subfields 301 to 308 is set so that the relative brightness ratio of the eight subfields is 1:2:4:8:16:32:128. By controlling the on/off states of subfields 301 to 308 in accordance with the display brightness of the data, 256 grayscales can be expressed by the various subfield combinations.

Subfields 301 to 308 are each constituted from initialization period 309, write period 310, and a sustain period 311. The durations of initialization period 309 and write period 310 are uniform across the subfields, while the duration of sustain period 311 corresponds to the relative brightness level of individual subfields. For example, when displaying images on panel unit 100 shown in FIG. 1, an initialization discharge is firstly generated in all of the discharge cells in initialization period 309, initializing the cells. This eliminates the effect of discharges generated in the preceding subfield and absorbs any variance in the discharge properties.

Next, in write period 310, a slight discharge (address discharge) is generated between scan electrodes 14 and data electrodes 22 in accordance with the subfield data. This discharge causes wall charge to accumulate on the surface of protective layer 16 over sustain electrode 13 and scan electrode 14 in the discharge cells D that are to be turned on (see FIG. 2). The accumulation of wall charge resulting from the address discharge is not enough to reach the discharge starting voltage in the cells. For example, voltages of 160-200 V, 80-120 V, and 60-90 V are applied respectively to sustain electrodes 13, scan electrodes 14, and data electrodes 22 in write period 310.

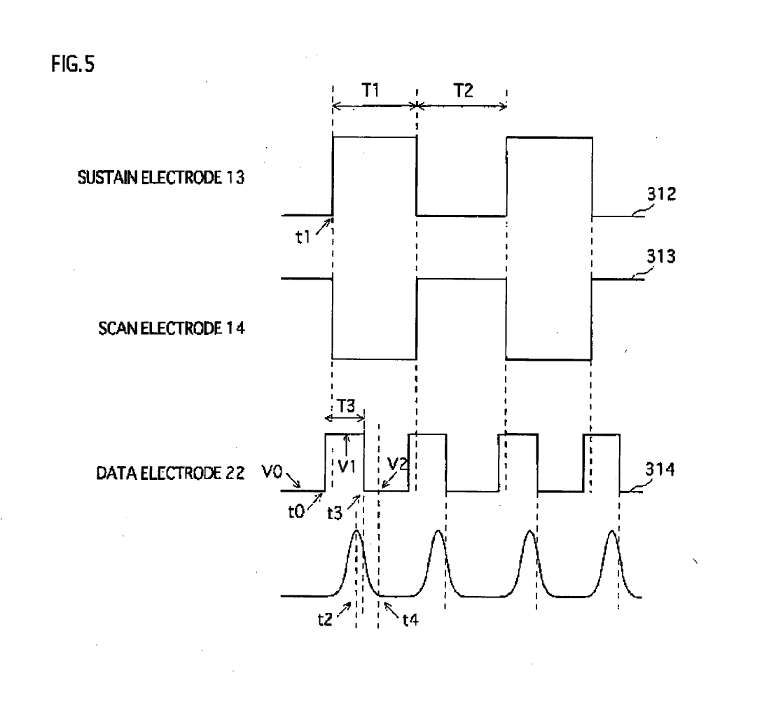

Then, in sustain period 311, rectangular sustain pulse waveforms 312 and 313 having a predetermined voltage (e.g. 180-220 V; typically 200 V) and cycle (e.g. 6 μsec) are applied simultaneously to sustain electrodes 13 and scan electrodes 14 across an entirety of panel unit 100, so as to be out of phase by half a cycle. Here, a rectangular sustain data pulse waveform 314 having a predetermined voltage (e.g. 60-90 V; typically 75 V) and cycle is applied to data electrodes 22 in sustain period 311, as shown in FIG. 4. Sustain data pulse 314 is described below using FIG. 5.

As shown in FIG. 5, pulse waveforms 312 and 313, whose high (e.g. 180-220 V; typically 200 V)/low (e.g. 0 V) potentials are set to have durations T1 and T2, respectively, are applied to sustain electrodes 13 and scan electrodes 14 in sustain period 311 so as to be out of phase by 180 degrees. As shown in FIG. 5, T1-T2 according to the example given in embodiment 1. Sustain data pulse 314 is set to rise from potential V0 (e.g. 0 V) to V1 (e.g. 60-90 V; typically 75 V) in a vicinity of the rise/fall times of sustain pulses 312 and 313, and to fall at a time t3 (i.e. after the elapse of a duration T3 from the rise time).

In view of suppressing any deterioration of phosphor layers 25 resulting from the drive, potential V1 typically is set in a range that will not cause a discharge between the data electrodes and either the sustain or scan electrodes when sustain data pulse 314 is applied.

As described above, sustain data pulse 314 is set to rise from potential V0 to V1 at time t0, and to fall at time t3 after the elapse of a certain time period from the rise/fall time t1 of sustain pulses 312, 313. The rise/fall timing of sustain data pulse 314 is set based on the following methodology. As shown in FIG. 3, the cycle of sustain data pulse 314 is set to be half that of sustain pulses 312, 313. In embodiment 1, time t0 is set to precede time t1 temporally, so as to ensure that the rise time of sustain data pulse 314 occurs prior to the sustain discharge.

As shown by the luminance waveform in FIG. 5, the sustain discharge in the discharge cells occurs a little after the rise/fall time t1 of sustain pulses 312 and 313 applied to sustain electrodes 13 and scan electrodes 14, and ends at time t4 after peaking at time t2. Sustain data pulse 314 is set to have a rise time t0 before the sustain discharge occurs, and to have a fall time t3 between times t2 and t4 of the luminance waveform. In other words, a feature of PDP device 1000 pertaining to embodiment 1 is the setting of sustain data pulse waveform 314 to have a rise time t0 prior to the sustain discharge and a fall time t4 during the sustain discharge.

The luminance waveform can be observed using infrared light radiated by the sustain discharge.

### 1-4. Superior Properties of PDP Device 1000

As a result of conducting experiments to measure luminance efficiency while varying the rise time and pulse width of sustain data pulse 314 applied to data electrodes 22 in sustain period 311, the inventors determined that luminance efficiency is maximized irrespective of the rise time or width of pulse 314, when the fall time of pulse 314 occurs in a certain range after the rise or fall time of sustain pulses 312 and 313 applied to sustain electrodes 13 and scan electrodes 14. The inventors thus concluded that the fall time of sustain data pulse 314 applied to data electrodes 22 in sustain period 311 is crucial to improving luminance efficiency.

PDP device 1000 as described above is able to sustain high luminance efficiency with respect to various panel configurations (e.g. cell structure, condition of gas enclosed in discharge space A, etc.), by having sustain data pulse 314 rise prior to the sustain discharge and setting a fall time t3 to be during the sustain discharge. More specifically, charge particles resulting from discharges shift according to the bias conditions (electric field intensity distribution) at the time, forming wall charge. If sustain data pulse 314 is set to have a fall time t3 after the sustain discharge, charge is formed in discharge space A while the potential of data electrodes 22 is still at V1. If this case, even when sustain data pulse 314 corresponding to the following sustain discharge is raised, the bias conditions simply return to their state at the time that the wall charge was last formed, neutralizing the effect of sustain data pulse 314.

Also, setting sustain data pulse 314 to have a fall time t3 that is too early with respect to the sustain discharge may result in the potential of data electrodes 22 falling before the sustain discharge, making it impossible to modulate the sustain discharge.

In contrast, with PDP device 1000 it is possible to modulate the sustain discharge in sustain period 311 by setting sustain data pulse 314 to have a rise time t0 that is prior to the sustain discharge and a fall time t3 that is during the sustain discharge.

It is thus possible with PDP device 1000 to maintain high luminance efficiency during the drive. To obtain high luminance efficiency, the fall time t3 of sustain data pulse 314 typically is set to be within a period equal to 80% of the time constant of the sustain discharge.

### 1-5. Verification

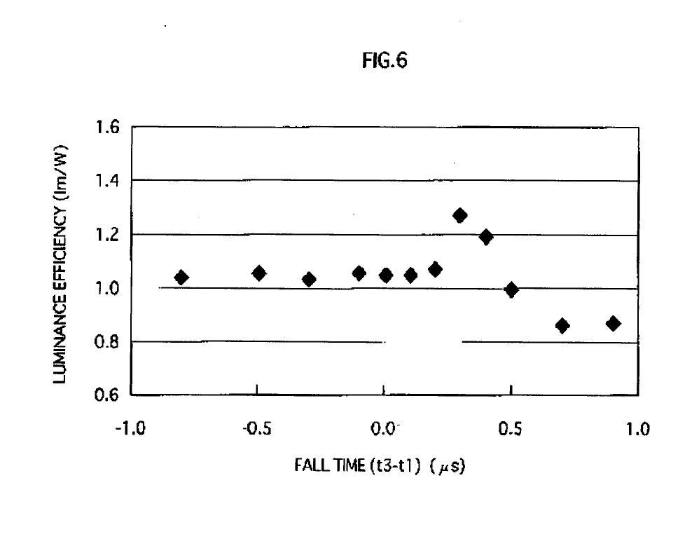

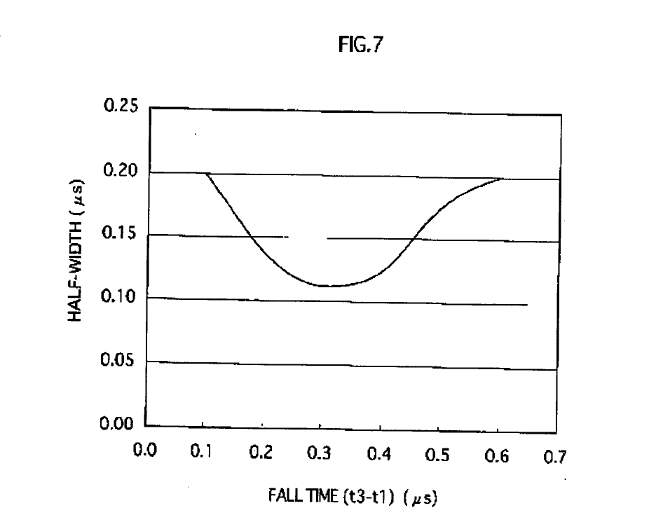

The superior properties of PDP device 1000 are verified below using FIGS. 6 and 7. FIG. 6 is a characteristic diagram showing the relationship between luminance efficiency and the fall time t3 of sustain data pulse 314. The vertical axis marks luminance efficiency, and the horizontal axis marks the time period from time t1 (i.e. when sustain pulses 312, 313 begin to rise/fall) until time t3 (i.e. when sustain data pulse 314 begins to fall). FIG. 7 is a characteristic diagram showing the relationship between the half-width of the luminance waveform (i.e. of the sustain discharge) and the fall time t3 of sustain data pulse 311. In the FIGS. 6 and 7 example, the rise and fall of sustain pulses 312 and 313 have slopes that require 250 nsec±20% to rise/fall.

The measurements and conditions for obtaining FIGS. 6 and 7 are as follows: sustain/scan electrode gap=80 μm (micrometer), barrier rib high 120 μm (see FIG. 1); T1=T2=2.5 μsec, T3=0.3 μsec (see FIG. 5). The time (t3-t1) in FIGS. 6 and 7 is the fall time of sustain data pulse 314.

As shown in FIG. 6, the luminance efficiency exhibits little change up until time (t3-t1)=0.1 μsec (microsecond). As mentioned above, this is thought to be due to the inability to modulate the sustain discharge because of the fall time t3 of sustain data pulse 314 being too early with respect to the sustain discharge.

When time (t3-t1) increases above 0.1 μsec, luminance efficiency falls below that at time (t3 t1)−0.1 μsec. As mentioned above, this is thought to be due to the effect of applying sustain data pulse 314 being neutralized by the fall time t3 of sustain data pulse 314 being too late with respect to the sustain discharge.

As shown in FIG. 7, the half-width of the luminance waveform shown on the vertical axis is reduced when time (t3-t1) is later than 0.1 μsec, reaching a minimum value of 0.11 at time (t3-t1)=0.3 μsec. Conversely, the half-width increases at times (t3-t1) beyond this point. These results show that the half-width of the luminance waveform varies depending on time (t3-t1), and that the half-width and luminance efficiency are respectively minimized and maximized when time (t3-t1)=0.3 μsec.

As shown in FIGS. 6 and 7, high luminance efficiency can thus be obtained by setting time (t3-t1) in a range of 0.1 μsec to 0.5 μsec under the panel conditions described above, and typically in a range of 0.2 μsec to 0.4 μsec. As mentioned above, time (t3-t1) is set to be during the sustain discharge, and typically in a time period that is 80% of the time constant of the sustain discharge.

The FIGS. 6 and 7 characteristic diagrams give only one example, the optimal fall time (t3-t1) of sustain data pulse 314 varying depending or the configuration of the panel. The superior properties of PDP device 1000 pertaining to embodiment 1 are obtained by setting the fall time of sustain data pulse 314 to be during the sustain discharge.

When the rise/fall sections of sustain pulses 312 and 313 are sloped, a certain time period is required for the potential to change from high to low or from low to high. Using the point in time when the potentials of sustain pulses 312 and 313 begin to change as a reference, it is necessary to vary time (t3-t1) depending on the slope of sustain pulses 312 and 313. For example, if 250 nsec (nanoseconds) is required for sustain pulses 312 and 313 to rise/fall, the ranges given above can be applied to time (t3-t1).

On the other hand, if 500 nsec is required for sustain pulses 312 and 313 to rise/fall, the optimal range for setting time (t3-t1) is 0.3 μsec to 0.7 μsec, and typically 0.4 μsec to 0.6 μsec.

Here, a duration T required for sustain pulses 312 and 313 to rise/fall typically is in a range having a width of ±20% with respect to a reference value typically in a range of 250 nsec to 800 nsec, and more typically in a range of 250 nsec to 500 nsec. When duration T required for sustain pulses 312 and 313 to rise/fall is within this range, time (t3-t1) typically is set to be in a range of T−0.15 μsec to T+0.25 μsec. This range more typically is T−0.05 μsec to T+0.15 μsec.

### Embodiment 2

Next, a PDP device 1100 pertaining to an embodiment 2 is described.

### 2-1. Overall Structure and Drive Method of PDP Device 1100

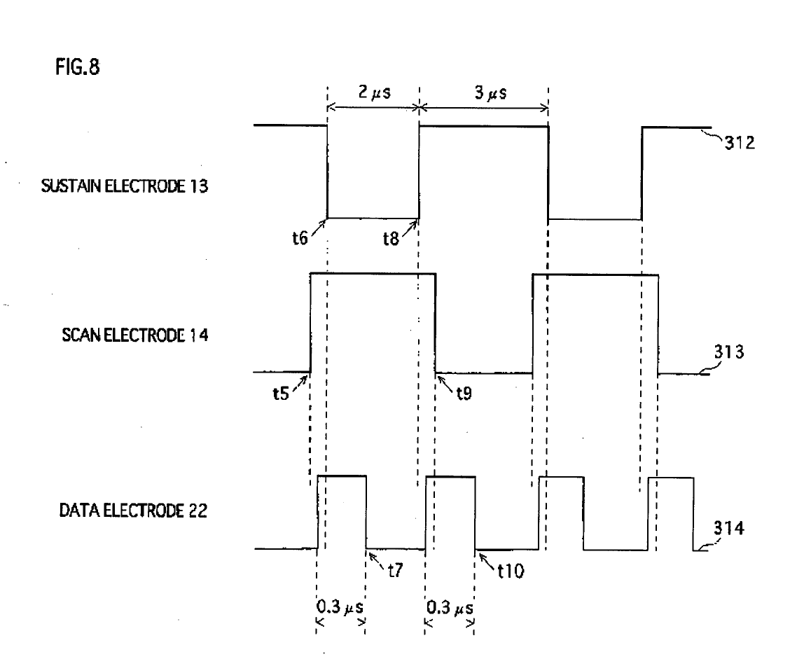

The structure of PDP device 1100 is similar to PDP device 1000 pertaining to embodiment 1. PDP device 1100 has the same measurements as the PDP device described in section 1-5 above, and the drive method is basically the same as that shown in FIG. 4. PDP device 1100 differs from PDP device 1000 with respect to the waveforms of sustain pulses 312/313 and sustain data pulse 314 applied in sustain period 311. This difference is described below using FIG. 8.

As shown in FIG. 8, sustain pulses 312 and 313 applied to sustain electrodes 13 and scan electrodes 14 in sustain period 313 during the drive of PDP device 1100 are set so that the high potential (e.g. 180-220 V; typically 200 V) period is longer than the low potential (e.g. 0 V) period. More specifically, the high and low periods of sustain pulses 312 and 313 are set to 3 μsec and 2 μsec, respectively. The pulse waveforms applied respectively to sustain electrodes 13 and scan electrodes 14 are set to be out of phase by 180 degrees. The fall and rise times of sustain pulse 312 applied to sustain electrodes 13 are set to begin at times t6 and t8, respectively. The rise and fall times of sustain pulse 313 applied to scan electrodes 14 are set to begin at times t5 and t9, respectively. Here, the rise time of sustain data pulse 314 is set to be earlier than the fall time of sustain pulse 312 (time t6 in FIG. 8).

On the other hand, sustain data pulse 314 applied to data electrodes 22 is set to have, for example, a voltage of 60-90 V (typically 75 V), a pulse width of 0.3 μsec and to fall at times t7 and t10. As with PDP device 1000, the fall times t7 and t10 of sustain data pulse 314 with respect to PDP device 1100 are set to be during the sustain discharge.

The potential of sustain data pulse 314 after the rise period is set in a range that will not cause a discharge between the data electrodes and either the sustain or scan electrodes when pulse 314 is applied.

Sustain pulses 312/313 and sustain data pulse 314 are set using the same circuit structure as that of PDP device 1000 shown in FIG. 1. Since the creation and execution of pulse generation computer programs is possible using known techniques, a detailed description of the circuitry structure is omitted here.

### 2-2 Setting of Fall Times t7, t10

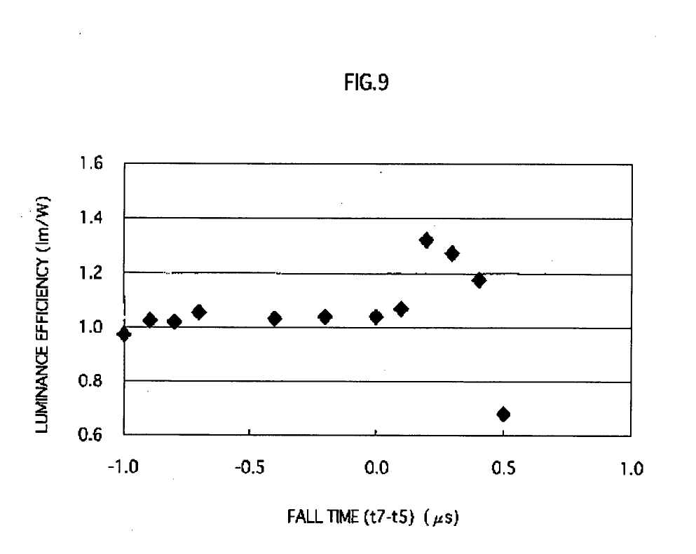

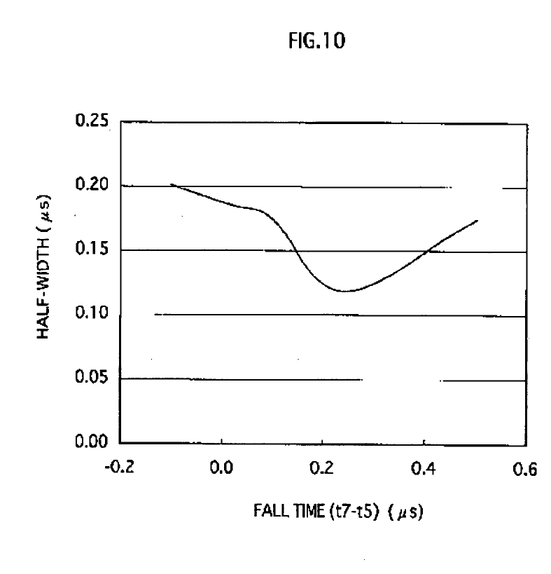

Typical fall times t7 and t10 in PDP device 1100 employing the above drive method are considered below using FIGS. 9 and 10. In both FIGS. 9 and 10, fall time t7 of sustain data pulse 314 is set using time t5 (i.e.. when sustain pulse 313 applied to scan electrodes 14 begins to rise) as a reference. A time (t7-t5) is thus marked on the horizontal axis of FIGS. 9 and 10.

As shown in FIG. 9, the luminance efficiency of PDP device 1100 exhibits little change up until time (t7-t5)=0.0 μsec. An increase in luminance efficiency is observed when time (t7-t5) is in a range of 0.0 μsec to 0.5 μsec. However, luminance efficiency decreases rapidly when time (t7-t5) is set to values greater than 0.5 μsec.

As shown in FIG. 10, the half-width of the luminance waveform is drastically reduced when time (t7-t5)is delayed beyond 0.0 μsec, and then increases after reaching a low point at around 0.2 μsec.

Consequently, increases in luminance efficiency can be achieved during the drive of PDP device 1100 by setting the fall times t7 and t10 of sustain data pulse 314 either to be the same as times t5 and t8 (i.e. when sustain pulse 313 and 312 begin to rise) or to have no more than a 0.5 μsec delay from times t5 and t8. In order achieve considerable improvements in luminance efficiency times (t7-t5) and (t10-t8) are typically set in a range of 0.1 μsec to 0.4 μsec.

The reasons for being able to achieve improvements in luminance efficiency by setting the timing of sustain data pulse 314 are the same as those given in embodiment 1.

When the rise/fall sections of sustain pulses 312 and 313 are sloped, a certain time period is required for the potential to change from high to low and vice versa. Using the point in time when the potentials of sustain pulses 312 and 313 begin to change as a reference, it is necessary to vary times (t7-t5) and (t10-t8) depending on the slope of sustain pulses 312 and 313. For example, when sustain pulses 312 and 313 take 250 nsec to rise/fall, the ranges given above can be applied in setting times (t7-t5) and (t10-t8).

On the other hand, when sustain pulses 312 and 313 take 500 nsec to rise/fall, times (t7-t5) and (t10-t8) are set in a range of 0.2 μsec to 0.7 μsec, and typically in a range of 0.3 μsec to 0.5 μsec.

Here, duration T required for sustain pulses 312 and 313 to rise/fall is, the same as embodiment 1, typically in a range having a width of ±20% with respect to a reference value typically in a range of 250 nsec to 800 nsec, and more typically in a range of 250 nsec to 500 nsec. When duration T required for sustain pulses 312 and 313 to rise/fall is within this range, times (t7-t5) and (t10-t8) typically are set to be in a range of T−0.25 μsec to T+0.25 μsec. This range more typically is T−0.15 μsec to T+0.15 μsec.

### Embodiment 3

Next, a PDP device 1200 pertaining to an embodiment 3 is described.

### 3-1. Drive Method for PDP Device 1200

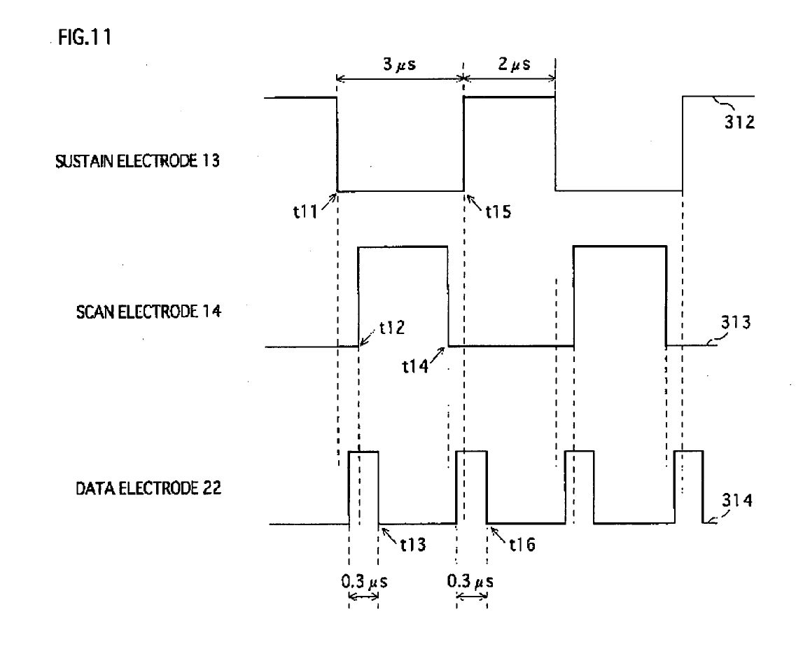

The structure of PDP device 1200 is similar to PDP devices 1000 and 1100 pertaining to embodiments 1 and 2. PDP device 1200 has the same measurements as the PDP device described in section 1-5 above, and the drive method is basically the same as that shown in FIG. 4. PDP device 1200 differs from PDP devices 1000 and 1100 with respect to the waveforms of sustain pulses 312/313 and sustain data pulse 314 applied in sustain period 311. This difference is described below using FIG. 11.

As shown in FIG. 11, sustain pulses 312 and 313 applied to sustain electrodes 13 and scan electrodes 14 in sustain period 311 during the drive of PDP device 1100 are set so that the high potential. (e.g. 180-220 V, typically 200 V) period is shorter than the low potential (e.g. 0 V) period. Specifically, the high and low periods of sustain pulses 312 and 313 are set to 2 μsec and 3 μsec, respectively. The pulse waveforms applied respectively to sustain electrodes 13 and scan electrodes 14 are set to be out of phase by 180 degrees. The fall and rise times of sustain pulse 312 applied to sustain electrodes 13 are set to begin at times t11 and t15, respectively. The rise and fall times of sustain pulse 313 applied to scan electrodes 14 are set to begin at times t12 and t14, respectively. Here, the rise time at sustain data pulse 314 is set to be earlier than the rise time of sustain pulse 313 (time t12 in FIG. 11).

On the other hand, data pulse 314 applied to data electrodes 22 is set to have, for example, a voltage of 60-90 V (typically 75 V), a pulse width of 0.3 μsec (i.e. same as embodiment 2) and to fall at times t13 and t16. As with PDP devices 1000 and 1100, the fall times t13 and t16 of sustain data pulse 314 with respect to PDP device 1200 are set to be during the sustain discharge.

Sustain pulses 312/313 and sustain data pulse 314 can be set using the same circuitry structure as embodiments 1 and 2.

### 3 2 Setting of Fall Times t13,t16

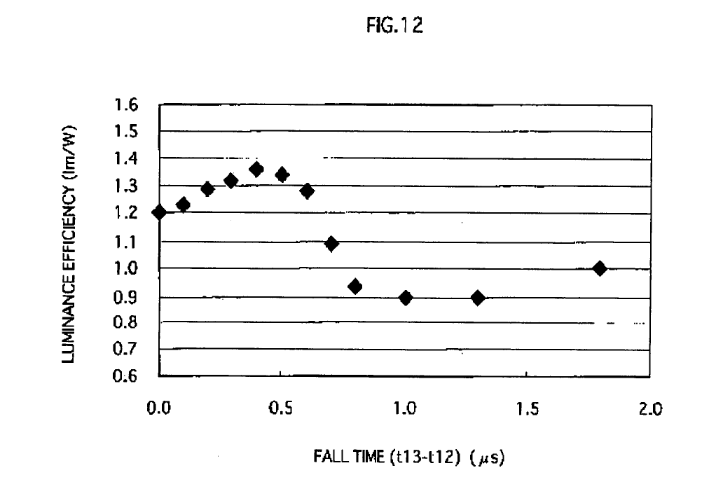

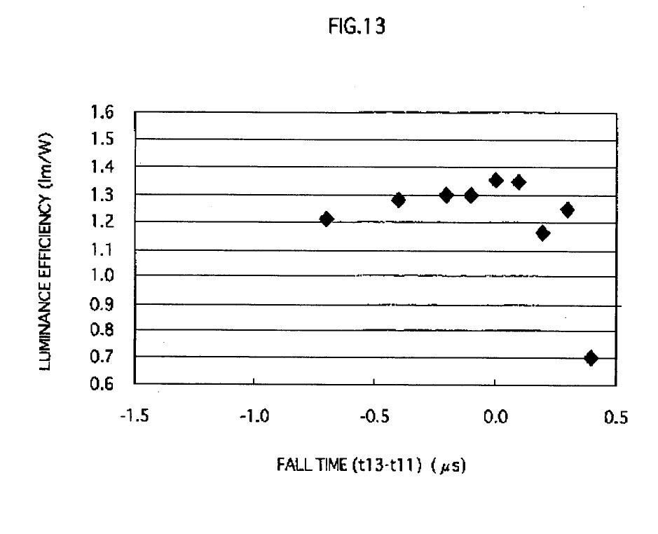

Typical fall times t13 and t16 in PDP device 1200 employing the above drive method are considered below using FIGS. 12 to 14. In FIG. 12, fall time t13 of sustain data pulse 314 is set using time t12 (i.e. when sustain pulse 313 applied to scan electrodes 14 begins to rise) as a reference. In contrast, in FIG. 13 fall time t13 is set using time t11 (i.e. when sustain pulse 312 applied to scan electrodes 13 begins to fall) as a reference.

As shown in FIG. 12, the luminance efficiency of PDP device 1200 is observed to increase when time (t13-t12) is set in a range of 0.2 μsec to 0.6 μsec, and typically in a range of 0.3 μsec to 0.5 μsec.

As shown in FIG. 13, when fall time t11 is taken as a reference, the luminance efficiency of PDP device 1200 is observed to increase when time (t13-t11) is set in a range of −0.2 μsec to 0.2 μsec, and typically in a range of −0.1 μsec to 0.1 μsec.

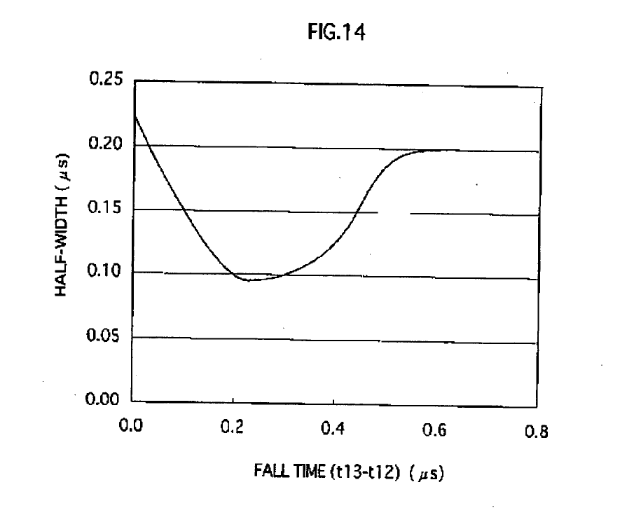

As shown in FIG. 14, the half-width of the luminance waveform takes a small value when time (t13-t12) is set in a range of 0.2 μsec to 0.6 μsec, and typically in a range of 0.3 μsec to 0.5 μsec. We know that luminance efficiency is increased within these ranges.

Consequently, if the high potential periods of sustain pulses 312 and 313 are shorter than the low potential periods, it is possible to obtain high luminance efficiency if the fall times t13 and t16 of sustain data pulse 314 are delayed in a range of 0.2 μsec to 0.6 μsec, and typically in a range of 0.3 μsec to 0.5 μsec, when using the times at which sustain pulses 312 and 313 begin to rise as a reference.

Also, if the times at which sustain pulses 312 and 313 begin to fall are used as a reference, high luminance efficiency can be obtained if the fall times t13 and t16 of sustain data pulse 314 are delayed in a range of −0.2 μsec to 0.2 μsec, and typically in a range of −-0.1 μsec to 0.2 μsec.

When the rise/fall sections of sustain pulses 312 and 313 are sloped, a certain time period is required for the potential to change from high to low and vice versa. Using the point in time when the potentials of sustain pulses 312 and 313 begin to change as a reference, it is necessary to vary the times (t13-t11) and (t13-t12) depending on the slope of sustain pulses 312 and 313. For example, when sustain pulses 312 and 313 take 250 nsec to rise/fall, the ranges given above can be applied in setting times (t13-t11) and (t13-t12).

On the other hand, when sustain pulses 312 and 313 take 500 nsec to rise/fall, time (t13-t12) is set in a range of 0.4 μsec to 0.8 μsec, and typically in a range of 0.5 μsec to 0.7 μsec. Under the same conditions, time (t13-t11) is set in a range of 0.0 μsec to 0.4 sec, and typically in a range of 0.1 μsec to 0.3 μsec.

Here, duration T required for sustain pulses 312 and 313 to rise/fall is, the same as embodiments 1 and 2, typically in a range having a width of ±20% with respect to a reference value typically in a range of 250 nsec to 800 nsec, and more typically in a range of 250 nsec to 800 nsec. When duration T required for sustain pulses 312 and 313 to rise/fall is within this range, time (t13-t12) typically is set to be in a range of T−0.5 μsec to T+0.35 μsec, and time (t13-t11) typically is set to be in a range of T−0.45 μsec to T−0.05 μsec. These ranges more typically are T+0.05 μsec to T+0.25 μsec for time (t13-t12), and T−0.35 μsec to T−0.15 μsec for time (t13-t11).

### Mechanisms for Achieving Luminance Efficiency Improvements in Embodiments 1 to 3

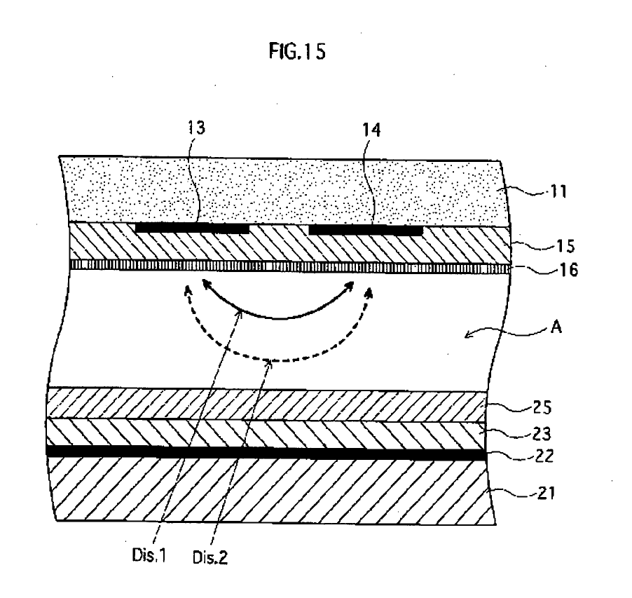

In the above embodiments 1 to 3, the luminance efficiency of the panel is improved by setting the fall time of sustain data pulse 314 to be during the sustain discharge. The mechanisms for achieving this are described below using FIG. 15. FIG. 15 schematically shows the path of a discharge generated in discharge space A when sustain data pulse 314 is applied during sustain period 311.

As shown in FIG. 15, the discharge path is Dis.1 either when sustain data pulse 314 is not applied in sustain period 311 or when sustain data pulse 314 does not fall at the times described in embodiments 1 to 3. In contrast, the discharge path is Dis.2 if sustain data pulse 314 is applied so as to fall at the times described in embodiments 1 to 3. Dis.2 is longer than Dis.1, and approaches closer to phosphor layers 25 and data electrodes 22. The inventors have identified that improving the luminance efficiency of the panels in PDP devices 1000 to 1200 pertaining to embodiments 1 to 3 is closely related to the change in the discharge path from Dis.1 to Dis.2. The nature of this relationship is described below.

Firstly, by applying sustain data pulse 314 using the fall times described in embodiments 1 to 3, the path Dis.2 of the sustain discharge is pulled towards back panel 2. As a result, a large positive column region is achieved when the sustain discharge occurs, allowing for improvements in ultraviolet production efficiency during the drive of PDP devices 1000 to 1200.

It is possible to reduce any loss resulting from the self-absorption of ultraviolet light, by having discharge path Dis.2 approach close to back panel 2 during the drive of PDP devices 1000 to 1200.

Using the above two mechanisms, it is possible to improve luminance efficiency with respect to PDP devices 1000 to 1200.

It should be noted that although luminance efficiency increases when the potential of sustain data pulse 314 applied to data electrodes 22 in sustain period 311 is raised, this may cause a discharge to occur between the data electrodes and either the sustain or scan electrodes prior to the sustain discharge between the sustain and scan electrodes. Such a discharge between the data electrodes and either the sustain or scan electrodes generally has the effect of increasing the deterioration of phosphor layers disposed on back panel 2 facing into discharge space A.

In contrast, the high potential of sustain data pulse 314 in embodiments 1 to 3 is set in a range that does not cause a discharge to occur between the data electrodes and either the sustain or scan electrodes when sustain data pulse 314 is applied. As a result, a discharge is not generated between data electrodes and either the sustain or scan electrodes when sustain data pulse 314 is applied, preventing any deterioration of phosphor layers 25.

Although exemplary AC PDP devices are described in the above embodiments 1 to 3, the present invention (including the drive method) is not limited to the structures shown in FIGS. 1 to 3. For example, it is also possible to provide electrodes other than the sustain, scan, and data electrodes, and to modulate the sustain discharge by applying pulses to the newly provided electrodes. In this case, the potential of the new electrodes should be changed during the sustain discharge. Moreover, it is not necessary for these new electrodes to be covered by dielectric layer 23.

### Embodiment 4

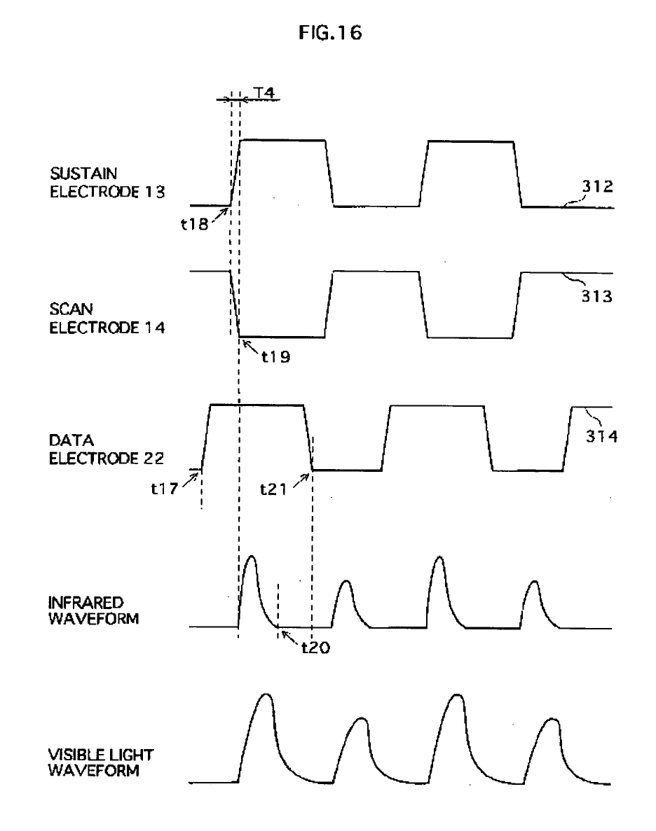

Next, a PDP device 1300 pertaining to an embodiment 4 will be described using FIG. 16. FIG. 16 is a chart showing the waveforms of pulses 312, 313 and 314 applied respectively to electrodes 13, 14 and 22 in sustain period 311. FIG. 16 also shows an infrared waveform and a visible light waveform observed when pulses 312, 313 and 314 are applied. Here, the infrared waveform results from measuring the intensity of infrared light generated by Xe discharges within the discharge gas. The infrared waveform is used as an indicator showing the duration of discharges. The visible light waveform is a luminance waveform resulting from the excitation of phosphor layers 25 by ultraviolet light generating from discharges.

Since the structure of PDP device 1300 and the drive, except for sustain period 311, is the same as embodiments 1 to 3, a description of these aspects is omitted here.

As shown in FIG. 16, sustain pulses 312 and 313 having waveforms whose rise/fall sections are sloped, are applied to sustain electrodes 13 and scan electrodes 14 in sustain period 311. The waveforms of sustain pulses 312 and 313 applied respectively to sustain electrodes 13 and scan electrodes 14 are set to be out of phase by 180 degrees. Time t18 marks when sustain pulses 312 and 313 begin to rise/fall, respectively. Time t19 marks when sustain pulses 312 and 313 have fully risen/fallen, respectively.

The high (e.g. 180-220 V; typically 200 V)/low (e.g. 0 V) potential periods of sustain pulses 312 and 313 are of equal duration.

On the other hand, sustain data pulse 314 applied to data electrodes 22 is set to rise from time t17, which is earlier than the rise/fall time t18 of sustain pulses 312 and 313, and to fall by time t21, which is after the end time t20 of the sustain discharge. Sustain data pulse 314 is applied using a cycle equal to that of sustain pulses 312 and 313.

In PDP device 1300 employing this drive method, wall charge is formed over data electrodes when sustain data pulse 314 is at a low level. When sustain data pulse 314 rises prior to the next sustain discharge, the discharge path is lengthened as with Dis.2 shown in FIG. 15, and pulled towards phosphor layers 25 as a result of the superposed effect of the wall charge accumulated on data electrodes 22 and the newly applied sustain data pulse 314. As a result, a high luminance waveform appears in each cycle of sustain pulses 312 and 313, allowing luminance efficiency of approximately 1.3 times that of conventional PDP devices (i.e. sustain data pulse 314 not applied) to be realized.

As shown in FIG. 16, sustain data pulse 314 is set to have a cycle equal to that of sustain pulses 312 and 313. Thus, as shown in FIG. 16, a high luminance waveform appears in each cycle of sustain pulses 312 and 313. As a result, the improvement in luminance efficiency in PDP device 1300 pertaining to embodiment 4 is reduced in comparison with PDP devices 1000 to 1200 in embodiments 1 to 3.

However, with the drive of PDP device 1300, it is possible to sustain a stable luminance state without changing the level of sustain data pulse 314 during the sustain discharge, because of setting the pulse waveforms so that sustain data pulse 314 rises from time t17 prior to the sustain discharge, stays at a high level during the sustain discharge, and falls by time t21 after the sustain discharge.

Reasons for setting the fall time t21 of sustain data pulse 314 to be during the sustain discharge in terms of luminance efficiency are as stated in embodiments 1 to 3.

### Embodiment 5

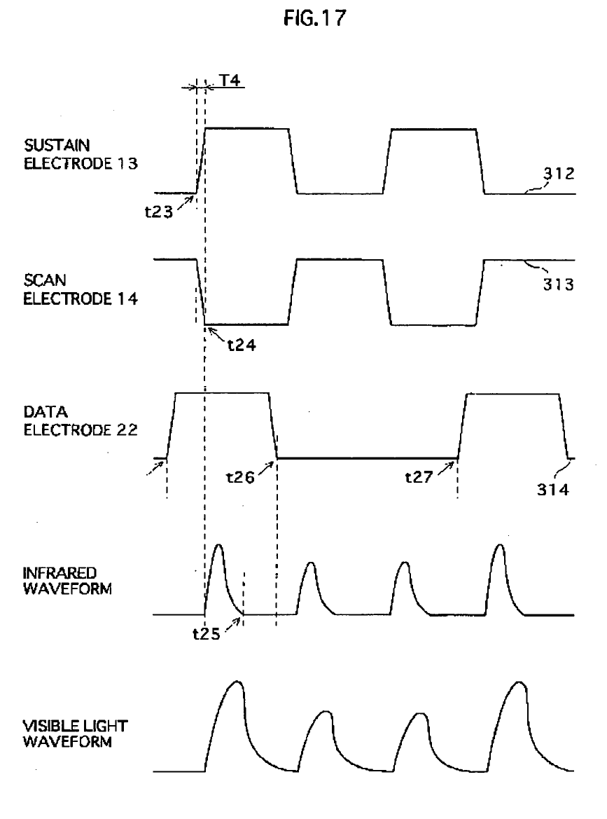

The drive method of a PDP device 1400 pertaining to an embodiment 5 is described below using FIG. 17. FIG. 17 is a chart showing the waveforms of pulses 312, 313 and 314 applied respectively to electrodes 13, 14 and 22 in sustain period 311. FIG. 17 also shows infrared and visible light waveforms observed when pulses 312, 313 and 314 are applied. Embodiment 5 differs from embodiment 4 with respect to the waveform of sustain data pulse 314. This waveform and the resultant effects are described below.

As shown in FIG. 17, a single cycle of sustain data pulse 314 is set to be 1.5 times that of sustain pulses 312 and 313.

By changing the high level cycle in the waveform of sustain data pulse 314 in an N^{th} sustain discharge (N being an integer), that is, by changing the duty ratio of sustain data pulse 314, it is possible to control the panel brightness of PDP device 1400. Controlling the panel brightness by means of the drive method is particularly effective in sustaining a high contrast in relation to dark video images.

Consequently, with PDP device 1400 pertaining to embodiment 5, it is possible to control reductions in contrast when displaying dark video images by controlling the durations for which sustain data pulse 314 is at high and low levels according to the illumination area of the video images for display.

In embodiment 5, the fall time t26 of sustain data pulse 314 is set to be after the end time t25 of the sustain discharge, although in terms of luminance efficiency, the fall time t26 of sustain data pulse 314 typically is set to be during the sustain discharge. The reasons for this are the same as those given in embodiments 1 to 3.

### Embodiment 6

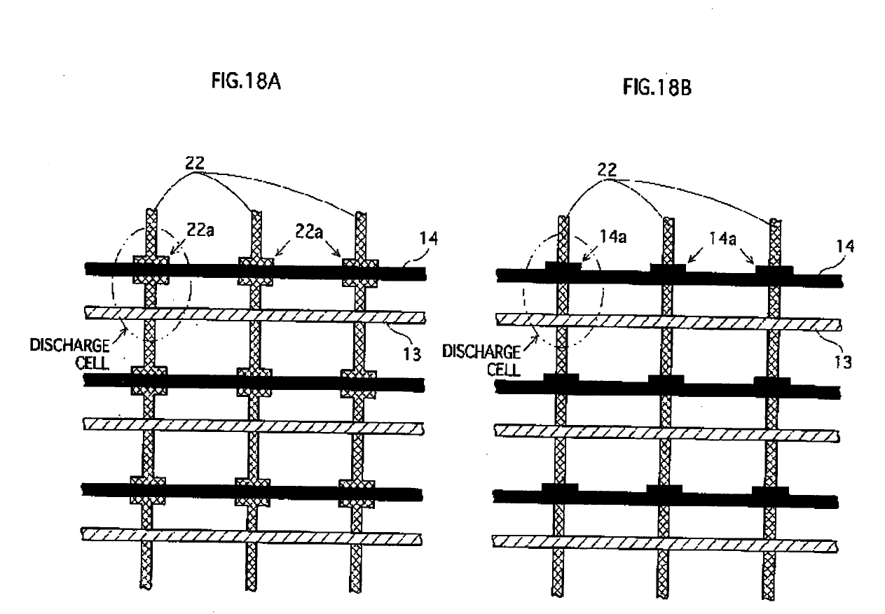

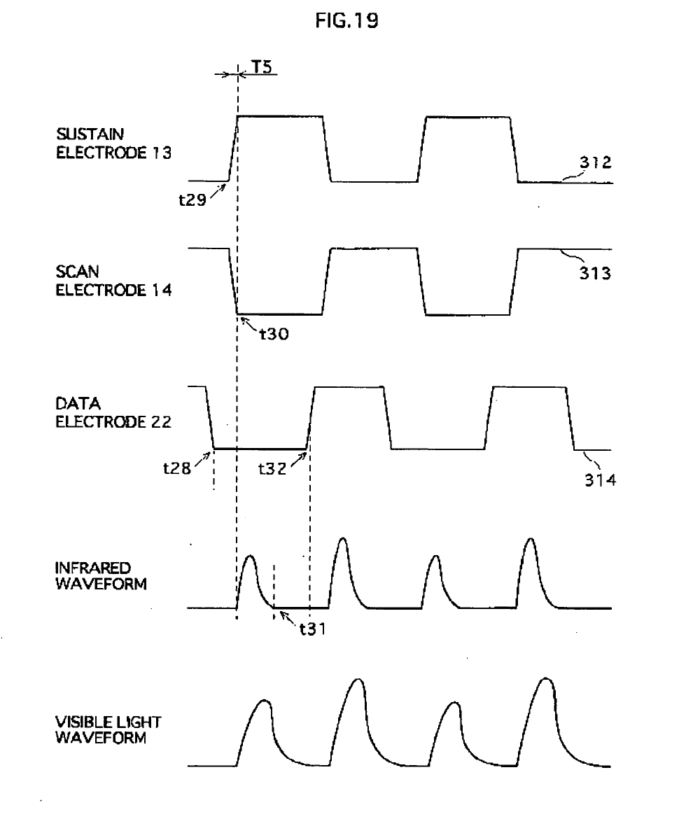

The configuration of electrodes 13, 14 and 22 and the drive method of a PDP device 150O pertaining to an embodiment 6 are described below using FIGS. 18A, 18B and 19. FIGS. 18A and 18B show configurations of electrodes 13, 14 and 22 within the panel unit of PDP device 1500.

As shown in FIG. 18A, sustain electrodes 13 and scan electrodes 14 are disposed in a stripe pattern on front panel 1, and data electrodes 22 are disposed on back panel 2 so as to intersects the sustain and scan electrodes. Here, a feature of embodiment 6 is that the electrode width of data electrodes 22 in a vicinity of the intersections with scan electrodes 14 is wider than in other areas. As a result of this electrode configuration, the binding capacity of scan electrodes 14 with data electrodes 22 in PDP device 1500 is greater than that of sustain electrodes 13 with data electrodes 22.

The binding capacities of the scan/data electrodes and sustain/data electrodes may, as shown in FIG. 18B, also be changed by increasing the width of scan electrodes 14 in a vicinity of the intersections with data electrodes 22.

The drive method of PDP device 1500 having the electrode configuration shown in FIG. 18A or 18B is described below using FIG. 19. FIG. 19 is a chart showing the waveforms of pulses 312, 313 and 314 applied respectively to electrodes 13, 14 and 22 in sustain period 311 during the drive of PDP device 1500.

As shown in FIG. 19, sustain pulses 312 and 313 applied to sustain electrodes 13 and scan electrodes 14 in sustain period 311 have sloping rise/fall sections. The respective slopes of sustain pulses 312 and 313 are set so that a period T5 (e.g. 250 nsec, 500 nsec) is required from the start (time t29) until the end (time t30) of the rise/fall.

On the other hand, sustain data pulse 314 applied to data electrodes 22 is set to stay at a low level during the sustain discharge after falling at time t28 prior to the rise/fall time t29 of sustain pulses 312 and 313, and to rise after the fall time t31 of the infrared waveform (i.e. at time t32 after the sustain discharge).

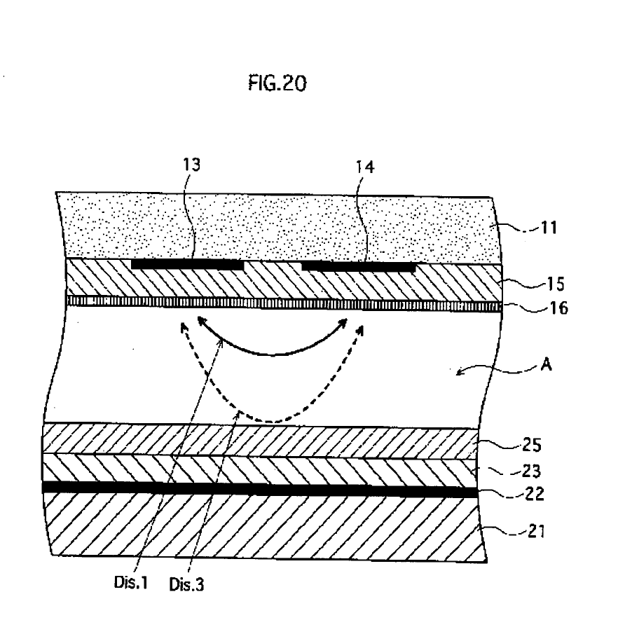

In PDP device 1500 employing this drive method, large amounts of wall charge are formed due to the sustain discharge generated when sustain data pulse 314 is at a low level, and then by raising sustain data pulse 314 to a high level prior to the next sustain discharge, luminance efficiency improves in comparison with PDP device 1400, due to the superposed effect of the wall charge formed over data electrodes 22 and the newly applied sustain data pulse 314. The reasons for this effect are described below using FIG. 20.

As shown in FIG. 20, when sustain data pulse 314 is applied in sustain period 311 according to the above timing, the length of the positive column increases in comparison with Dis.1 (i.e. sustain data pulse not applied), This increases the produced amount of ultraviolet light and moves discharge path Dis.3 closer to phosphor layers 25. The efficiency with which ultraviolet light reaches phosphor layers 25 is improved as a result.

Consequently, a luminance waveform having high brightness occurs in each cycle of sustain pulses 312 and 313, making it possible to obtain high luminance efficiency of approximately 1.6 times that of conventional PDP devices employing a drive method in which a sustain data pulse is not applied.

The same effects can be obtained when either of the electrode configurations shown in FIGS. 18A and 18B are employed.

Although in embodiment 6, sustain data pulse 314 is applied to data electrodes 22 in sustain period 311, it is not necessary to use data electrodes 22. For example, the same effects can be obtained, even when sustain data pulse 314 is applied to new electrodes provided on back panel 2, a differential being provided between the binding capacities of the new electrodes with scan electrodes 14 and sustain electrodes 13, respectively.

### Embodiment 7

Next, the structure and drive method of a PDP device 2000 pertaining to an embodiment 7 is described.

### 7-1. Overall Structure of PDP Device 2000

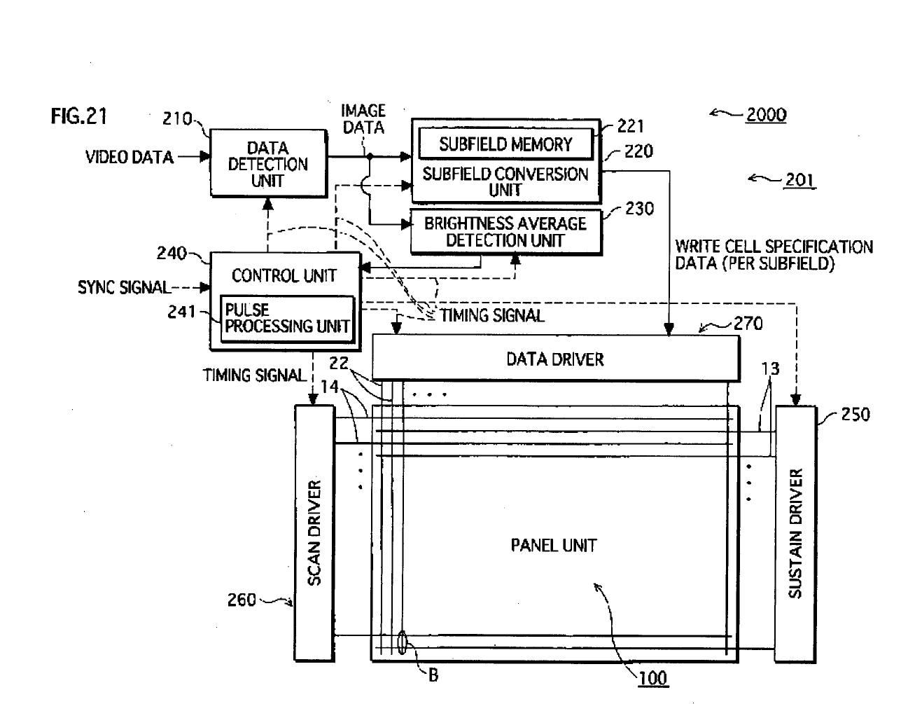

The structure of PDP device 2000 is described below using FIG. 21. FIG. 21 is a block diagram showing the structure of PDP device 2000. The basic structure is the same as embodiment 1 shown in FIG. 1.

As shown in FIG. 21, PDP device 2000 differs from PDP device 1000 in relation to the structure of the drive unit, particularly the method for setting sustain data pulse 314. Description of the structure of panel unit 100 and other areas that are similar to embodiment 1 is omitted here.

As shown in DIG. 21, a brightness-average detection unit 230 (i.e. not included in PDP device 1000) is provided in a drive unit 201 of PDP device 2000. Image data is inputted to brightness-average detection unit 230 from data detection unit 210, and unit 230 is connected so as to enable signals to be outputted to control unit 240.

More specifically, brightness-average detection unit 230 derives a grayscale average based on image data for individual screens transferred from data detection unit 210 that shows the grayscale value of each cell. To calculate the grayscale average, unit 230 adds together all of the grayscale values for an individual screen and divides the result by the total number of cells. Unit 230 derives the brightness average by calculating the grayscale average as a percentage of the highest grayscale value (e.g. 255). Unit 230 send data relating to the derived brightness average to control unit 240.

Control unit 240, in addition to the functions of control unit 240 in PDP device 1000, sends a timing signal to brightness-average detection unit 230 indicating a timing at which the brightness average is to be calculated, and sets the optimal fall time of sustain data pulse 314 applied to data electrodes 22 in sustain period 311, based on the data relating to the brightness average received from unit 230. Data relating to the optimal fall time set by unit 240 is outputted as a timing signal to a sustain data pulse oscillator (not depicted) in data driver 270.

On receipt of this timing signal, data driver 270 applies sustain data pulse 314 to all of data electrodes 22 in sustain period 311 at the optimal fall time set based on the brightness average.

### 7-2. Drive Method for PDP Device 2000

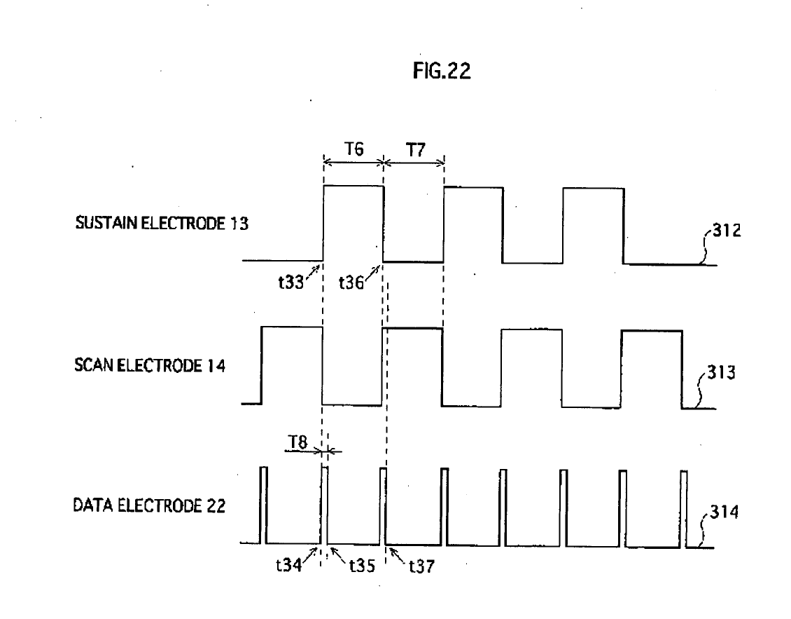

The drive method for PDP device 2000 is described below using FIG. 22. FIG. 22 is a chart showing the waveforms of pulses 312, 313 and 314 applied respectively to electrodes 13, 14 and 22 in sustain period 311.

As shown in FIG. 22, sustain pulses 312 and 313 applied to sustain electrodes 13 and scan electrodes 14 in sustain period 311 alternate repeatedly between high and low levels. The high and low levels of sustain pulses 312 and 313 are set to durations T6 and T7 respectively. Sustain pulses 312 and 313 are set to have a cycle (i.e. T6+T7) of 2.5 μsec, for example.

Sustain pulses 312 and 313 applied respectively to sustain electrodes 13 and scan electrodes 14 are set to be out of phase by 180 degrees. Sustain pulse 313 is thus set to fall at the rise time t33 of sustain pulse 312. Although not depicted in FIG. 22, the rise/fall sections of the sustain pulse waveforms actually have a regular slope.

On the other hand, sustain data pulse 314 applied to data electrodes 22 is set to rise at time t34 in sync with the rise/fall time t33 of sustain pulses 312 and 313, and to have a fall time t35 that is a duration T8 (e.g. 0.3 μsec) after the rise time t34.

In PDP device 2000, the discharge starting voltage is surpassed due to the superposed effect of sustain pulse 312 and 313 and the wall charge accumulated over scan electrodes 14 from the write discharge generated in write period 310.

### 7-3. Setting of Sustain Data Pulse 314

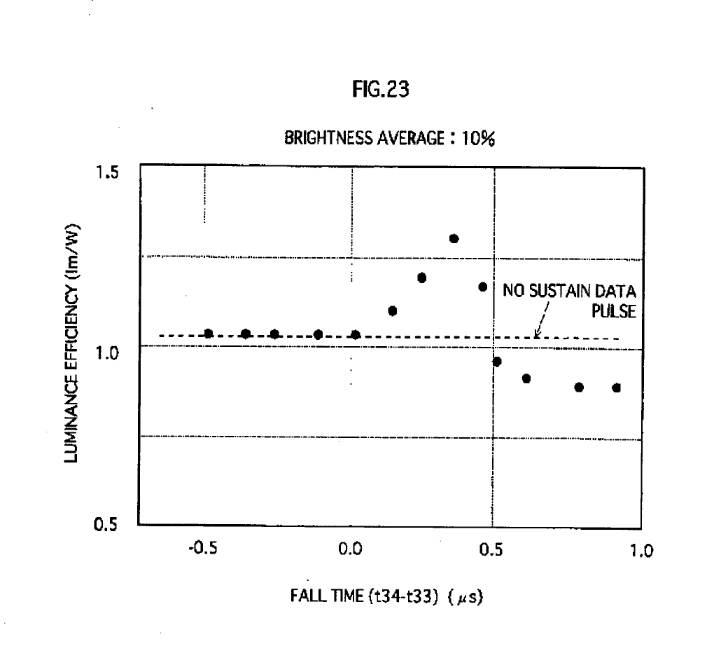

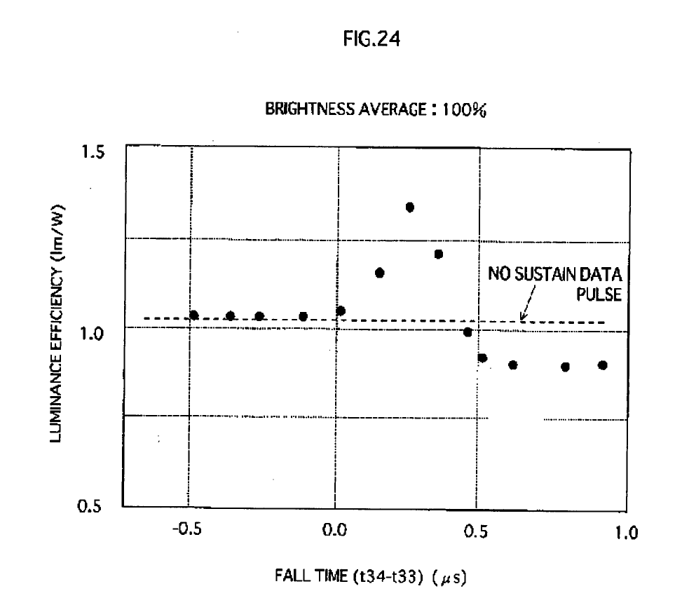

The inventors have observed that when sustain data pulse 314 is applied to data electrodes 22 in sustain period 311, the optimal fall times t35 and t37 of sustain data pulse 314 at which the luminance efficiency of PDP device 2000 is maximized, varies with changes in the brightness average of images for display. This effect is described below using FIGS. 23 and 24. FIGS. 23 and 24 are characteristic diagrams plotting the luminance efficiency of PDP device 2000 on the vertical axis and time (t35-t33) on the horizontal axis, for brightness averages of 10% and 100%, respectively. Here, time (t35-t33) is the fall time of sustain data pulse 314.

As shown in FIG. 23, at a brightness average of 10% (low), luminance efficiency varies at a result of sustain data pulse 314 being applied to data electrodes 22. Luminance efficiency is maximized when time (t35-t33) is set to approximately 0.3 μsec.

As shown in FIG. 24, on the other hand, at a brightness average of 100% (high), luminance efficiency is maximized when time (t35-t33) is set to approximately 0.2 μsec.

In their attempt to maximize the luminance efficiency of PDP device 2000, the inventors observed that this can be achieved by varying the duration from time t33 (i.e. when sustain pulses 312 and 313 begin to rise/fall) until the fall time t35 of sustain data pulse 314 according to the brightness average of images for display. Although yet to be ascertained, one possible reason for this is the differing electric field distribution states in discharge space A when wall charge is being formed, depending on the brightness average of images for display.

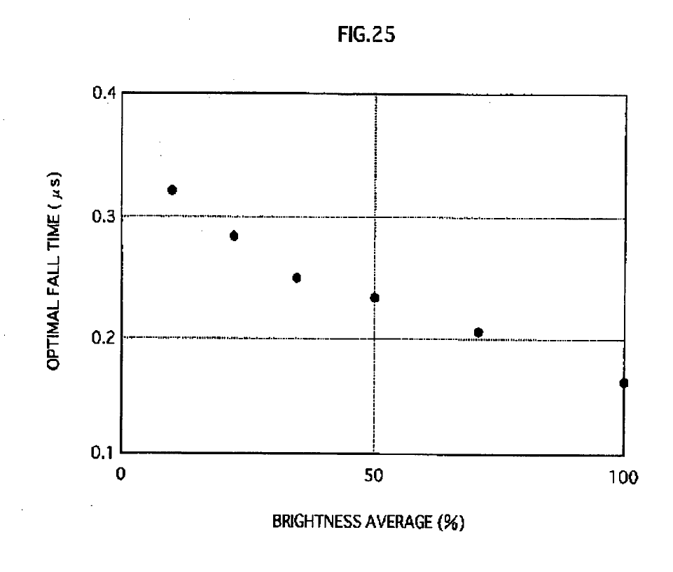

As such, the inventors conducted investigations into the relationship between the brightness average of an image and fall time t35 of sustain data pulse 314. The results of the investigation are described below using FIG. 25. FIG. 25 is a characteristic diagram plotting the relationship between the optimal fall time of sustain data pulse 314 in sustain period 314 and the brightness average of an image for display.

As shown in FIG. 25, the optimal fall time t35 of sustain data pulse 314 to increase luminance efficiency moves closer to time t33 as the brightness average increases. Consequently, by calculating the brightness average of images for display and controlling the fall time t35 of sustain data pulse 314 according to the calculated brightness average, it is possible to maximize luminance efficiency in PDP device 2000 for different brightness averages.

### 7-4. Control of Sustain Data Pulse 314

The timing signal that relates to the application of sustain data pulse 314 outputted to data driver 270 by control unit 240 is controlled as follows.

A table (not depicted) in which the brightness averages shown in FIG. 25 are corresponded to various fall times t35 of sustain data pulse 314, is stored in pulse-processing unit 241, which is included in control unit 240. Here, a clock pulse is counted using a narrower pulse width than the pulse width T8 of sustain data pulse 314 (not depicted), and the optimal fall time t35 of sustain data pulse 314 is set in pulse-processing unit 241 based on the counted number of clock pulses (CLK).

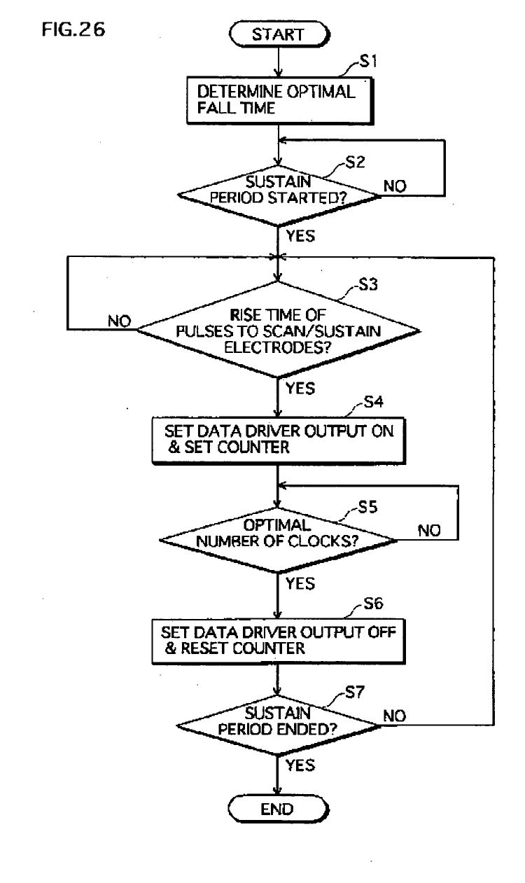

The control method implemented by controlling pulse-processing unit 241 is described below using FIGS. 26 and 27. FIG. 26 is a control flow diagram relating to pulse-processing unit 241. FIG. 27 is a chart showing the waveforms of pulses 312, 313 and 314 applied respectively to electrodes 13, 14 and 22 in sustain period 311. FIG. 27 also shows the number of clock pulses (CLK) for controlling the application timing of these pulses.

As shown in FIG. 26, when information relating to a brightness average is inputted from brightness-average detection unit 230, pulse processing unit 241 refers to the stored table and sets the fall time t35 of sustain data pulse 314 (step S1).

If during sustain period 311 (step S2-YES), pulse-processing unit 241 waits for sustain pulses 312 and 313 to be applied to the sustain and scan electrodes. Unit 241 then drives data driver 270 in sync with the start of the rise times of sustain pulses 312 and 313, as shown in FIG. 27 (step S4). As a result, sustain data pulse 314 applied to all of the data electrodes is controlled to rise. Here, unit 241 shown in FIG. 21 includes a clock counter (not depicted) for counting clock pulses (CLK). Unit 241 resets the clock counter in sync with the fall time t35 of sustain data pulse 314 (step S4).

When sustain data pulse 314 reaches the optimal fall time, that is, when the counter value CT reaches the number of clock pulses (four clocks in FIG. 27) that equates to the set optimal fall time (step S5=YES), pulse-processing unit 241 changes the output of data driver 27 to an OFF-state so as to make sustain data pulse 314 fall, and resets the clock counter (step S6). Unit 241 repeats this operation until the end of sustain period 311 (step S7).

With PDP device 2000, it is possible according to this control method to apply a sustain data pulse to data electrodes 22 in sustain period 311 that has been set to an optimal fall time according to the brightness average of image data.

Here, in terms of the control circuit for implementing these controls, it is possible to apply a known circuit as disclosed in unexamined Japanese patent application publication no.2002-536689 (note: control target differs from present invention).

### Embodiment 8

### 8-1. Structure and Drive Method for PDP Device 3000 Pertaining to Embodiment 8

In embodiment 7, the fall time t35 of sustain data pulse 314 is changed according to the brightness average of image data. In embodiment 8, the fall time of sustain data pulse 314 is furthermore changed according to the temperature of panel unit 100. Since panel unit 100 in PDP device 3000 has the same structure as that of panel unit 100 in PDP device 2000 in embodiment 7, description is omitted here.

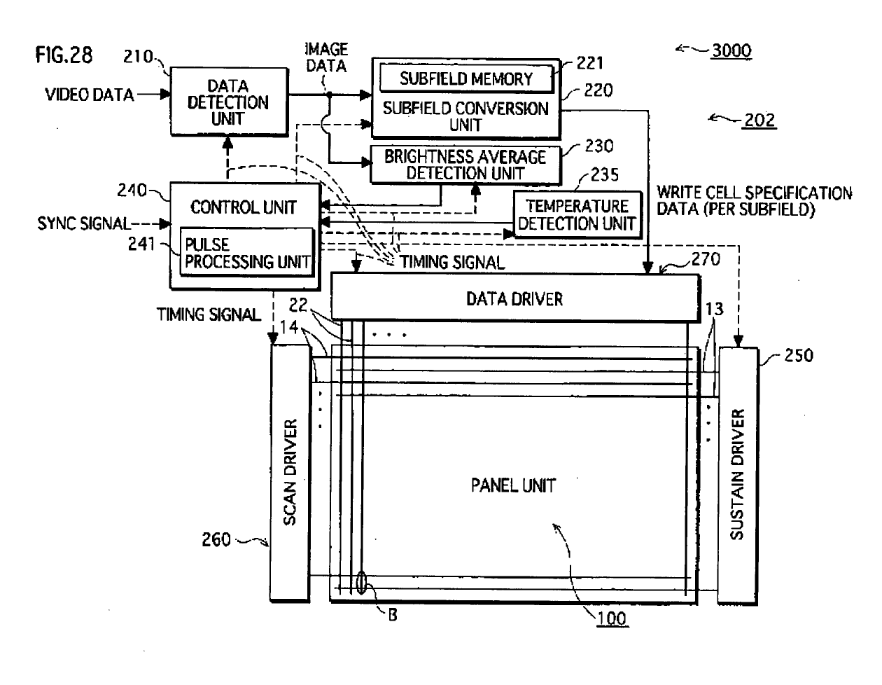

FIG. 28 is a block diagram showing the structure of PDP device 3000 pertaining to embodiment 8. Components having the same structures in embodiments 7 and 8 are marked in FIGS. 21 and 28 using the same reference numerals. The following description focuses on the features of embodiment 8.

In PDP device 3000, a thermistor (not depicted) is provided in panel unit 100, and drive unit 202 includes a temperature detection unit 235, as shown in FIG. 28, for detecting the temperature of panel unit 100 using the thermistor. Temperature detection unit 235 sends temperatures detected for each field to control unit 240 in response to a control signal from unit 240.

A plurality of tables (not depicted), as in embodiment 7, in which brightness averages correspond to optimal fall times of sustain data pulse 314, are provided in correspondence with various temperatures (e.g. from 27° C. to 65° C. in 1° C. increments), and these tables are stored in pulse-processing unit 241 of control unit 240. Each of these tables is created in advance by measuring the optimal sustain data pulse fall time/brightness average relationship for the various panel temperatures. As with PDP device 2000, the optimal fall time of sustain data pulse 314 is converted to a number of clock pulses (CLK) having a narrower width than the pulse width of sustain data pulse 314, the fall time changing in response to this number.

Pulse-processing unit 241 performs controls using basically the same steps as those shown in the FIG. 26 flow diagram. However, a difference lies in the determining of the optimal fall time at step 1. In embodiment 8, the table corresponding to a detected temperature is selected, and the selected table referred to.

### 8-2. Setting of Optimal Fall Time

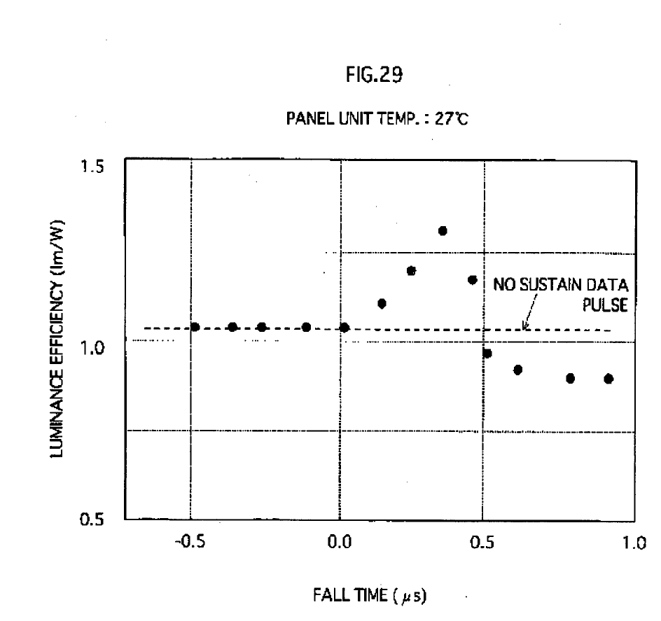

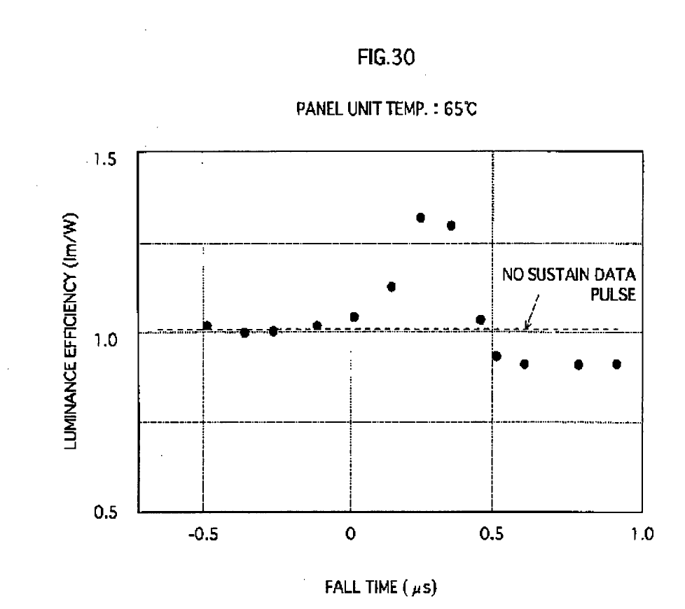

The method for setting the optimal fall time of sustain data pulse 314 in PDP device 3000 is described below using FIGS. 29 and 30. FIGS. 29 and 30 are characteristic diagrams plotting the luminance efficiency of the panel and the fall time of sustain data pulse 314 at temperatures in panel unit 100 of 27° C. and 65° C., respectively.

As shown in FIG. 29, we know that luminance efficiency in PDP device 3000 is maximized when the fall time of sustain data pulse 314 is delayed by approximately 0.3 μsec from when sustain pulses 312 and 313 applied to the sustain and electrodes begin to change in sustain period 311.

As shown in FIG. 30, on the other hand, we know that luminance efficiency in PDP device 3000 is maximized when the fall time of sustain data pulse 314 is delayed by approximately 0.25 μsec from when sustain pulses 312 and 313 applied to the sustain and scan electrodes begin to change in sustain period 311.

As shown above, we know that with PDP device 3000, the optimal fall time of sustain data pulse 314 differs depending on the temperature of panel unit 100. Although yet to be ascertained, one possible reason for this is panel-temperature related changes in the properties of the protective layer and the like on which wall charge is formed, and the consequent variation in the electric field distribution state in discharge space A.

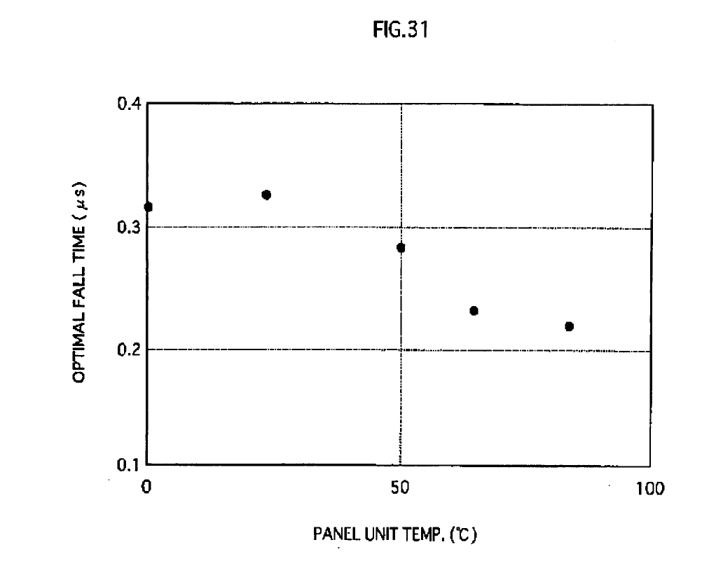

The relationship between the temperature of panel unit 100 and the optimal fall time of sustain data pulse 314 in PDP device 3000 is described below using FIG. 31. FIG. 31 is a characteristic diagram depicting this relationship.

As shown in FIG. 31, the optimal fall time of sustain data pulse 314 is moved forward in time as the temperature of panel unit 100 increases.

Consequently, with PDP device 3000 it is possible to always obtain high luminance efficiency, irrespective of variations in the brightness average and panel temperature, by optimizing the fall time of sustain data pulse 314 according to the brightness average of images for display and the temperature of panel unit 100.

### Related Matters

While an AC-type PDP device is used in the description of embodiment 1 to 8, the present invention is not limited to the AC-type.

Numeric values in embodiments 1 to 8 are given as examples, and conditions relating to device size, componentry, and the drive are subject to change depending an various conditions.

Although in embodiments 1 to 8 the sustain data pulse is applied to the data electrodes in the sustain period, application of the sustain data pulse need not be to the data electrodes. For example, fourth electrodes may be provided in the panel unit, and the sustain data pulse applied to the fourth electrodes.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A plasma display panel device comprising;
a panel unit having a pair of a first and a second electrode, and a third electrode that intersects the electrode pair to define a discharge cell; and
a drive unit that drives the panel unit using a drive method having a write period and a sustain period, by applying, in the sustain period, a voltage to the third electrode and a voltage to the electrode pair, so as to generate a sustain discharge between the first and second electrodes in the sustain period, wherein
the drive unit changes a potential of the third electrode during the sustain discharge.

2. The plasma display panel device of claim 1, wherein
the change in the potential of the third electrode during the sustain discharge is a decrease from a potential V1 to a potential V2.

3. The plasma display panel device of claim 2, wherein
the drive unit increases the potential of the third electrode from a potential V0 to the potential V1 in the sustain period.

4. The plasma display panel device of claim 3, wherein the potentials V0 and V2 are equal.

5. The plasma display panel device of claim 3, wherein
the potentials V0 and V2 are set in a range that will a not cause a discharge to occur between the third electrode and the first or second electrode.

6. The plasma display panel device of claim 1, wherein
a waveform of the voltage applied to the third electrode in the sustain period is a pulse waveform, and
the change in the potential of the third electrode during the sustain discharge corresponds to a fall in the pulse waveform.

7. The plasma display panel device of claim 1, wherein
the change in the potential of the third electrode occurs in a period equal to 80% of a time constant of the sustain discharge.

8. The plasma display panel device of claim 1, wherein
the electrode pair is provided or a first substrate, and
the third electrode is provided on a second substrate that is disposed facing the first substrate across a discharge space.

9. The plasma display panel device of claim 8, wherein
one of the electrodes in the pair is a scan electrode and the other electrode in the pair is a sustain electrode, and
the third electrode is a data electrode.

10. The plasma display panel device of claim 1, wherein
a waveform of the voltage applied to the electrode pair in the sustain period has a slope requiring a duration T to at least one of rise and fall.

11. The plasma display panel device of claim 10, wherein
T is in a range having a width of ±20% with respect to a reference value in a range of 250 nsec to 800 nsec.

12. The plasma display panel device of claim 11, wherein
the reference value of T is in a range of 250 nsec to 500 nsec.

13. The plasma display panel device of claim 10, wherein
the voltage waveform applied to the electrode pair in the sustain period is a pulse waveform that alternates repeatedly between high and low potentials, the high periods being of equal duration to the low periods, and
the change in the potential of the third electrode occurs in a range of T−0.15 μsec to T+0.25 μsec after the voltage waveform applied to at least one of the first and second electrode begins to change.

14. The plasma display panel device of claim 13, wherein
the change in the potential of the third electrode from V1 to V2 occurs in a range of T−0.05 μsec to T+0.15 μsec after the voltage waveform applied to at least one of the first and second electrode begins to change.

15. The plasma display panel device of claim 13, wherein
the potential of the third electrode decreases from a potential V1 to a potential V2 in the range.

16. The plasma display panel device of claim 13, wherein the voltage waveform applied to the first electrode is out of phase with the voltage waveform applied to the second electrode by a half cycle.

17. The plasma display panel device of claim 10, wherein
the voltage waveform applied to the electrode pair in the sustain period is a pulse waveform that alternates repeatedly between high and low potentials, the high periods being longer than the low periods, and
the change in the potential of the third electrode occurs in a range of T−0.25 μsec to T+0.25 μsec after the voltage waveform applied to at least one of the first and second electrode begins to change.

18. The plasma display panel device of claim 17, wherein
the change in the potential of the third electrode from V1 to V2 occurs in a range of T−0.15 μsec to T+0.05 μsec after the voltage waveform applied to at least one of the first and second electrode begins to change.

19. The plasma display panel device of claim 17, wherein
the potential of the third electrode decreases from a potential V1 to a potential V2 in the range.

20. The plasma display panel device of claim 17, wherein
the voltage waveform applied to the first electrode is out of phase with the voltage waveform applied to the second electrode by a half cycle.

21. The plasma display panel device of claim 10, wherein
the voltage waveform applied to the electrode pair in the sustain period is a pulse waveform that alternates repeatedly between high and low potentials, the high periods being shorter than the low periods, and
the change in the potential of the third electrode occurs in a range of (i) T−0.05 μsec to T 0.35 μsec after the voltage waveform applied to at least one of the first and second electrode begins to rise, or (ii) T−0.45 μsec to T−0.05 μsec after the voltage waveform applied to at least one of the first and second electrode begins to fall.

22. The plasma display panel device of claim 21, wherein
the change in the potential of the third electrode from V1 to V2 occurs in a range of (i) T+0.05 μsec to T−0.25 μsec after the voltage waveform applied to at least one of the first and second electrode begins to rise, or (ii) T−0.35 μsec to T−0.15 μsec after the voltage waveform applied to at least one of the first and second electrode begins to fall.

23. The plasma display panel device of claim 21, wherein
the potential of the third electrode decreases from a potential V1 to a potential V2 in the range.

24. The plasma display panel device of claim 21, wherein
the voltage waveform applied to the first electrode is out of phase with the voltage waveform applied to the second electrode by a half cycle.

25. A plasma display panel device, comprising:
a panel unit having a pair of a first and a second electrode, and a third electrode that intersects the electrode pair to define a discharge cell; and
a drive unit that drives the panel unit using a drive method having a write period and a sustain period, by applying, in the sustain period, a voltage to the third electrode and a voltage to the electrode pair, so as to generate a sustain discharge between the first and second electrodes in the sustain period, wherein
the drive unit changes a potential of the third electrode from V0 to V1 prior to the sustain discharge, and from V1 to V2 after the sustain discharge, and
the potentials V0, V1 and V2 are set so that V1>V0 and V1>V2, or V0>V1 and V2>V1.

26. The plasma display panel device of claim 25, wherein
the drive unit increases the potential of the third electrode from V0 to V1 prior to a first sustain discharge, sustains the potential V1, and decreases the potential of the third electrode from V1 to V2 after a second sustain discharge that is subsequent to the first sustain discharge.

27. The plasma display panel device of claim 25, wherein
the drive unit decreases the potential of the third electrode from V0 to V1 prior to a first sustain discharge, sustains the potential V1, and increases the potential of the third electrode from V1 to V2 after a second sustain discharge that is subsequent to the first sustain discharge.

28. The plasma display panel device of claim 25, wherein
one of the electrodes in the pair is a scan electrode and the other electrode in the pair is a sustain electrode, and
the third electrode is a data electrode.

29. The plasma display panel device of claim 25, wherein
a cycle of the voltage waveform applied to the third electrode in the sustain period is an integer multiple of a cycle of the voltage waveform applied to the electrode pair.

30. The plasma display panel device of claim 29, wherein
one of the electrodes in the pair is a scan electrode and the other electrode in the pair is a sustain electrode, and
the third electrode is a data electrode.

31. The plasma display panel device of claim 25, wherein
a binding capacity of the first electrode with the third electrode is different from a binding capacity of the second electrode with the third electrode, and
the drive unit increases the potential of the third electrode when a potential of the electrode in the pair with the greater binding capacity is high.

32. The plasma display panel device of claim 31, wherein
one of the electrodes in the pair is a scan electrode and the other electrode in the pair is a sustain electrode, and
the third electrode is a data electrode.

33. A plasma display panel device, comprising:
a panel unit having a pair of a first and a second electrode, and a third electrode that intersects the electrode pair to define a discharge cell; and
a drive unit that drives the panel unit using a drive method having a write period and a sustain period, by applying, in the sustain period, a voltage to the third electrode and a voltage to the electrode pair, so as to generate a sustain discharge between the first and second electrodes in the sustain period, wherein
the drive unit includes:
a detection subunit operable to detect a characteristic of an image for display by the panel unit; and
a control subunit operable to perform a control in the sustain period to change a potential of the third electrode according to the detected characteristic.

34. The plasma display panel device of claim 33, wherein
the detection subunit detects a brightness average of the image as the characteristic.

35. The plasma display panel device of claim 34, wherein
the detection subunit further detects a temperature of the panel unit as the characteristic, and
the control subunit conducts the control based on the detected brightness average and temperature.

36. The plasma display panel device of claim 33, wherein
a waveform of the voltage applied to the third electrode in the sustain period is a pulse waveform;
the change in the potential of the third electrode during the sustain discharge corresponds to a fall in the pulse waveform.

37. The plasma display panel device of claim 33, wherein
the voltage waveform applied to the third electrode in the sustain period is in synchronization with the voltage waveform applied to the electrode pair.

38. The plasma display panel device of claim 33, wherein
the control by the control subunit is conducted at a fall time of the voltage waveform applied to the third electrode in the sustain period.

39. A plasma display panel device, comprising:
a panel unit having a pair of a first and a second electrode, and a third electrode that intersects the electrode pair to define a discharge cell; and
a drive unit that drives the panel unit using a drive method having a write period and a sustain period, by applying, in the sustain period, a voltage to the third electrode and a voltage to the electrode pair, so as to generate a sustain discharge between the first and second electrodes in the sustain period, wherein
in the sustain period the drive unit performs a control in which a potential of the third electrode is changed during the sustain discharge, so as to hasten the generation of the sustain discharge in comparison to when the potential is not changed.

40. A plasma display panel device comprising:
a panel unit having first and second substrates that face each other across a discharge space, a pair of a first and a second electrode being provided on the first substrate, and a phosphor layer and a third electrode that intersection the electrode pair to define a discharge cell being provided on the second substrate,
a drive unit that drives the panel unit using a drive method having a write period and a sustain period, by applying, in the sustain period, a voltage to the third electrode and a voltage to the electrode pair, so as to generate a sustain discharge between the first and second electrodes in the sustain period, wherein
in the sustain period, the drive unit performs a control in which a potential of the third electrode is changed during the sustain discharge, so as to shift a region in which the sustain discharge is generated closer to the phosphor layer in comparison to when the potential is not changed.

41. A plasma display panel device, comprising:
a panel unit having a pair of a first and a second electrode, and a third electrode that intersects the electrode pair to define a discharge cell; and
a drive unit that drives the panel unit using a drive method having a write period and a sustain period, by applying, in the sustain period, a voltage to the third electrode and a voltage to the electrode pair, so as to generate a sustain discharge between the first and second electrodes in the sustain period, wherein
in the sustain period, the drive unit performs a control in which a potential of the third electrode is changed during the sustain discharge, so as to shift a discharge path of the sustain discharge closer to the third electrode in comparison to when the potential is not changed.

42. A plasma display panel device, comprising:
a panel unit having a pair of a first and a second electrode, and a third electrode that intersects the electrode pair to define a discharge cell; and
a drive unit that drives the panel unit using a drive method having a write period and a sustain period, by applying, in the sustain period, a voltage to the third electrode and a voltage to the electrode pair, so as to generate a sustain discharge between the first and second electrodes in the sustain period, wherein
in the sustain period, the drive unit performs a control in which a potential of the third electrode is changed during the sustain discharge, so as to lengthen a discharge path of the sustain discharge in comparison to when the potential is not changed.

43. A drive method for a plasma display panel device that includes (i) a panel unit having a pair of a first and a second electrode and a third electrode that intersects the electrode pair to define a discharge cell, and (ii) a drive unit that drives the panel unit using the drive method, which has a write step and a sustain step, by applying, in the sustain step, a voltage to the third electrode and a voltage to the electrode pair, so as to generate a sustain discharge between the first and second electrodes, wherein
in the sustain step, the drive unit changes a potential of the third electrode during the sustain discharge.

44. The drive method of claim 43, wherein
the change in the potential of the third electrode during the sustain discharge is a decrease from a potential V1 to a potential V2.

45. The drive method of claim 44, wherein
in the sustain step, the drive unit increases the potential of the third electrode from a potential V0 to the potential V1.

46. The drive method of claim 45, wherein
the potentials V0 and V2 are equal.

47. The drive method of claim 45, wherein
the potentials V0 and V2 are set in a range that will a not cause a discharge to occur between the third electrode and the first or second electrode.

48. The drive method of claim 43, wherein
a waveform of the voltage applied to the third electrode in the sustain step is a pulse waveform, and
the change in the potential of the third electrode during the sustain discharge corresponds to a fall in the pulse waveform.

49. The drive method of claim 43, wherein
the change in the potential of the third electrode occurs in a period equal to 80% of a time constant of the sustain discharge.

50. The drive method of claim 43, wherein
a waveform of the voltage applied to the electrode pair in the sustain step has a slope requiring a duration T to at least one of rise and fall.

51. The drive method of claim 50, wherein
T is in a range having a width of ±20% with respect to a reference value in a range of 250 nsec to 800 nsec.

52. The drive method of claim 51, wherein
the reference value of T is in a ranges of 250 nsec to 500 nsec.

53. The drive method of claim 50, wherein
the voltage waveform applied to the electrode pair in the sustain step is a pulse waveform that alternates repeatedly between high and low potentials, the high periods being of equal duration to the low periods, and
the change in the potential of the third electrode occurs in a range of T−0.15 μsec to T+0.25 μsec after the voltage waveform applied to at least one of the first and second electrode begins to change.

54. The drive method of claim 53, wherein
the change in the potential of the third electrode from V1 to V2 occurs in a range of T−0.05 μsec to T+0.15 μsec after the voltage waveform applied to at least one of the first and second electrode begins to change.

55. The drive method of claim 53, wherein
the potential of the third electrode decreases from a potential V1 to a potential V2 in the range.

56. The drive method of claim 53, wherein
the voltage waveform applied to the first electrode is a out of phase with the voltage waveform applied to the second electrode by a half cycle.

57. The drive method of claim 50, wherein
the voltage waveform applied to the electrode pair in the sustain step is a pulse waveform that alternates repeatedly between high and low potentials, the high periods being longer than the low periods, and
the change in the potential of the third electrode occurs in a range of T−0.25 μsec to T+0.25 μsec after the voltage waveform applied to at least one of the first and second electrode begins to change.

58. The drive method of claim 57, wherein
the change in the potential of the third electrode from V1 to V2 occurs in a range of T−0.15 μsec to T+0.05 μsec after the voltage waveform applied to at least one of the first and second electrode begins to change.

59. The drive method of claim 57, wherein
the potential of the third electrode decreases from a potential V1 to a potential V2 in the range.

60. The drive method of claim 57, wherein
the voltage waveform applied to the first electrode is out of phase with the voltage waveform applied to the second electrode by a half cycle.

61. The drive method of claim 50, wherein
the voltage waveform applied to the electrode pair in the sustain step is a pulse waveform that alternates repeatedly between high and low potentials, the high periods being shorter than the low periods, and
the change in the potential of the third electrode occurs in a range of (i) T−0.05 μsec to T+0.35 μsec after the voltage waveform applied to at least one of the first and second electrode begins to rise, or (ii) T−0.45 μsec to T−0.05 μsec after the voltage waveform applied to at least one of the first and second electrode begins to fall.

62. The drive method of claim 61, wherein
the change in the potential of the third electrode from V1 to V2 occurs in a range of (i) T+0.05 μsec to T+0.25 μsec after the voltage waveform applied to at least one of the first and second electrode begins to rise, or (ii) T−0.35 μsec to T−0.15 μsec after the voltage waveform applied to at least one of the first and second electrode begins to fall.

63. The drive method of claim 61, wherein
the potential of the third electrode decreases from a potential V1 to a potential V2 in the range.

64. The drive method of claim 61, wherein
the voltage waveform applied to the first electrode is out of phase with the voltage waveform applied to the second electrode by a half cycle.

65. A drive method for a plasma display panel device that includes (i) a panel unit having a pair of a first and a second electrode and a third electrode that intersects the electrode pair to define a discharge cell, and (ii) a drive unit that drives the panel unit using the drive method, which has a write step and a sustain step, by applying, in the sustain step, a voltage to the third electrode and a voltage to the electrode pair, so as to generate a sustain discharge between the first and second electrodes, wherein
in the sustain step, the drive unit changes a potential of the third electrode from V0 to V1 prior to the sustain discharge, and from V1 to V2 after the sustain discharge, and
the potentials V0, V1 and V2 are set so that V1>V0 and V1>V2, or V0>V1 and V2>V1.

66. The drive method of claim 65, wherein
in the sustain step, the drive unit increases the potential of the third electrode from V0 to V1 prior to a first sustain discharge, sustains the potential V1, and decreases the potential of the third electrode from V1 to V2 after a second sustain discharge that is subsequent to the first sustain discharge.

67. The drive method of claim 66, wherein
in the sustain step, the drive unit decreases the potential of the third electrode from V0 to V1 prior to a first sustain discharge, sustains the potential V1, and increases the potential of the third electrode from V1 to V2 after a second sustain discharge that is subsequent to the first sustain discharge.

68. The drive method of claim 65, wherein
a cycle of the voltage waveform applied to the third electrode in the sustain step is an integer multiple of a cycle of the voltage waveform applied to the electrode pair.

69. The drive method of claim 65, wherein
a binding capacity of the first electrode with the third electrode is different from a binding capacity of the second electrode with the third electrode, and
the drive unit increases the potential of the third electrode when a potential of the electrode in the pair with the greater binding capacity is high.

70. A drive method for a plasma display panel device that includes (i) a panel unit having a pair of a first and a second electrode and a third electrode that intersects the electrode pair to define a discharge cell, and (ii) a drive unit that drives the panel unit using the drive method, which has a write step and a sustain step, by applying, in the sustain step, a voltage to the third electrode and a voltage to the electrode pair so as to generate a sustain discharge between the first and second electrodes, wherein
the drive unit detects a characteristic of an image for display by the panel unit, and performs a control in the sustain step to change a potential of the third electrode according to the detected characteristic.

71. The drive method of claim 70, wherein
the drive unit detects a brightness average of the image as the characteristic.

72. The drive method of claim 71, wherein
the drive unit further detects a temperature of the panel unit as the characteristic, and conducts the control based on the detected brightness average and temperature.

73. The drive method of claim 70, wherein
a waveform of the voltage applied to the third electrode in the sustain step is a pulse waveform;
the change in the potential of the third electrode during the sustain discharge corresponds to a fall in the pulse waveform.

74. The drive method of claim 70, wherein
the voltage waveform applied to the third electrode in the sustain step is in synchronization with the voltage waveform applied to the electrode pair.

75. The drive method of claim 70, wherein
in the sustain step, the control by the drive unit is conducted at a fall time of the voltage waveform applied to the third electrode.

76. A drive method for a plasma display panel device that includes (i) a panel unit having a pair of a first and a second electrode and a third electrode that intersects the electrode pair to define a discharge cell, and (ii) a drive unit that drives the panel unit using the drive method, which has a write step and a sustain step, by applying, in the sustain step, a voltage to the third electrode and a voltage to the electrode pair, so as to generate a sustain discharge between the first and second electrodes, wherein
in the sustain step, the drive unit performs a control in which a potential of the third electrode is changed during the sustain discharge, so as to hasten the generation of the sustain discharge in comparison to when the potential is not changed.

77. A drive method for a plasma display panel device that includes (i) a panel unit having a pair of a first and a second electrode, a third electrode that intersects the electrode pair to define a discharge cell, and a phosphor layer disposed over the third electrode, and (ii) a drive unit that drives the panel unit using the drive method, which has a write step and a sustain step, by applying, in the sustain step, a voltage to the third electrode and a voltage to the electrode pair, so is to generate a sustain discharge between the first and second electrodes, wherein
in the sustain step, the drive unit performs a control in which a potential of the third electrode is changed during the sustain discharge, so as to shift a region in which the sustain discharge is generated closer to the phosphor layer in comparison to when the potential is not changed.

78. A drive method for a plasma display panel device that includes (i) a panel unit having a pair of a first and a second electrode and a third electrode that intersects the electrode pair to define a discharge cell, and (ii) a drive unit that drives the panel unit using the drive method, which has a write step and a sustain step, by applying, in the sustain step, a voltage to the third electrode and a voltage to the electrode pair, so as to generate a sustain discharge between the first and second electrodes, wherein
in the sustain step the drive unit performs a control in which a potential of the third electrode is changed during the sustain discharge, so as to shift a discharge path of the sustain discharge closer to the third electrode in comparison to when the potential is not changed.

79. A drive method for a plasma display panel device that includes (i) a panel unit having a pair of a first and a second electrode and a third electrode that intersects the electrode pair to define a discharge cell, and (ii) a drive unit that drives the panel unit using the drive method, which has a write step and a sustain step, by applying, in the sustain step, a voltage to the third electrode and a voltage to the electrode pair, so as to generate a sustain discharge between the first and second electrodes, wherein
in the sustain step, the drive unit performs a control in which a potential of the third electrode is changed during the sustain discharge, so as to lengthen a discharge path of the sustain discharge in comparison to when the potential is not changed.
